(19) United States
(12) Patent Application Publication
(10) Pub. No.: US 2017/0064695 A1
(43) Pub. Date: Mar. 2, 2017

(54) TRANSMISSION PARAMETER CONTROL FOR IMMEDIATE RESPONSE FRAMES

(71) Applicant: QUALCOMM Incorporated, San Diego, CA (US)

(72) Inventors: Yan Zhou, San Diego, CA (US); Simone Merlin, San Diego, CA (US); Gwendolyn Denise Barriac, Encinitas, CA (US); George Cherian, San Diego, CA (US); Alfred Asterjadhi, San Diego, CA (US); Gang Ding, San Diego, CA (US); Qingjiang Tian, San Diego, CA (US)

(21) Appl. No.: 15/246,379

(22) Filed: Aug. 24, 2016

Related U.S. Application Data
(60) Provisional application No. 62/209,857, filed on Aug. 25, 2015.
(60) Provisional application No. 62/331,855, filed on May 4, 2016.

(51) Int. Cl. H04W 72/04; H04L 1/16; H04L 1/00; H04W 72/08

(52) U.S. Cl. CPC H04W 72/0413; H04W 72/082; H04L 1/16; H04L 1/0036

(57) ABSTRACT

Methods, systems, and devices are described for wireless communication. A transmitting device may transmit soliciting frames to a receiving device on a forward link. In response to the soliciting frames, the receiving device may transmit solicited frames in an immediate response back to the transmitting device on a reverse link. A solicited frame may fail to successfully decode at the transmitting device. The transmitting device in response may indicate an instantaneous value for one or more reverse link transmission parameters when sending a subsequent soliciting frame. The reverse link transmission parameters may be predetermined in a fixed mapping such that one or more values for the reverse link transmission parameters depend on values for the forward link transmission parameters. The receiving device may override the predetermined value and instead use the instantaneous value. An indicator of the instantaneous value may also be sent in a control field.

### CROSS REFERENCES

The present Application for Patent claims priority to U.S. Provisional Patent Application No. 62/209,857 by Zhou, et al., entitled “Transmission Parameter Control for Immediate Response Frames,” filed Aug. 25, 2015, and to U.S. Provisional Patent Application No. 62/331,855 by Zhou, et al., entitled “Transmission Parameter Control for Immediate Response Frames” filed May 4, 2016, assigned to the assignee hereof, and expressly incorporated by reference herein.

### BACKGROUND

The present disclosure relates generally to wireless communication, and more specifically to transmission parameter control for immediate response frames.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a wireless fidelity (Wi-Fi) (e.g., IEEE 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the STA, and the UL (or reverse link) may refer to the communication link from the STA to the AP.

An AP or STA may transmit data to another AP or STA, and the receiving device may respond with an acknowledgement or other immediate response frame. For example, an AP may transmit data to a STA on a DL, to which the STA may respond with a block acknowledgement (BA) on the UL, where the BA indicates whether the data was received and decoded successfully by the STA. A fixed or predetermined relationship or mapping between a transmission rate used for DL or UL data and the transmission rate to be used for an UL or DL transmission, respectively, sent in response to the DL or UL data may be used. For example, where the BA is an immediate BA to be sent on an UL (the reverse link), the transmission rate for the BA may be set in advance and fixed to be a predetermined transmission rate that may be based in part on the transmission rate for the data sent on the DL (the forward link). In some cases, the transmission parameters for the UL may be limited by the signal or other conditions for the DL, or vice versa. Because signal or other conditions for the DL and UL may be different, transmission rates that may be successfully used on the DL and UL may also be different.

In some examples, there may be an imbalanced interference in both the forward and reverse directions, and the fixed mapping between DL and UL transmission rates may introduce inefficiencies. In one example, a BA sent on the UL may be lost or unsuccessfully decoded by an AP, for example due to interference on the UL. Using the fixed mapping, a transmission rate on the DL may be adjusted down to a lower rate to make the BA rate on the UL more robust, even though the DL does not experience as much or the same types of interference as experienced on the UL. Thus, transmission inefficiencies may be introduced due to the presence of imbalanced interference.

### SUMMARY

Methods, systems, and apparatuses for transmission parameter control for immediate response frames are described. A transmitting device may transmit soliciting frames to a receiving device on a forward link. In response to the soliciting frames, the receiving device may transmit solicited frames in an immediate response back to the transmitting device on a reverse link. The reverse link transmission parameters may be predetermined in a fixed mapping such that one or more values for the reverse link transmission parameters depend on values for the forward link transmission parameters. A solicited frame may fail to successfully decode at the transmitting device. The transmitting device in response may indicate an instantaneous value for one or more reverse link transmission parameters when sending a subsequent soliciting frame. The receiving device, having been provided the instantaneous value with the soliciting frame, may then override the predetermined value and instead use the instantaneous value for the parameter when transmitting a solicited frame back to the transmitting device on the reverse link in response to the soliciting frame.

An instantaneous value for a reverse link transmission parameter (e.g., an immediate response rate) may also be explicitly or implicitly communicated by a transmitting device to a receiving device in a soliciting frame. The transmitting device may identify the instantaneous value for the reverse link parameter, then transmit a soliciting frame on a forward link indicating the identified instantaneous value for the reverse link transmission parameter in a control field. The receiving device may receive the soliciting frame, and identify, for example by inference, the presence of the instantaneous value based on the presence of the control field in the soliciting frame. The receiving device may then transmit a solicited frame back to the receiving device using the instantaneous value for the reverse link transmission parameter. Where a fixed mapping from the reverse link transmission parameter (e.g., a transmission rate) has been used by the receiving device to transmit solicited frames, the receiving device may override a value for the reverse link transmission parameter that the transmitting device would have otherwise determined based on a fixed mapping from the forward link transmission parameter to the reverse link transmission parameter to be used by the receiving device to transmit the solicited frame to the transmitting device.

The control field may be a high efficiency (HE) variant of a high throughput (HT) control field, such as a link adaptation field, an immediate response rate field, a trigger frame field, or a receiver operation mode indication (ROMI) field. The indicators of the instantaneous value may be a modulation and coding scheme (MCS) value, a number of spatial streams (NSS), or a combination of these. The instantaneous value may also indicated in the control field, or an indicator included in the control field to indicate that the presence of the instantaneous value in the control field.

In an example, the solicited frame is a block acknowledgement (BA) associated with a soliciting frame that is a received data block, and the reverse link transmission parameter may be a BA rate that depends on the data rate of the received data block according to some fixed mapping. In other example, a soliciting frame may be a retransmitted data frame or a block acknowledgement request (BAR) frame sent to indicate the instantaneous value. In other examples, the reverse link transmission parameters may be assigned an instantaneous value, in addition to a transmission rate such as a BA rate, may be any parameter affecting the robustness or signal quality of the reverse link, for example a bandwidth channel set, transmit power, spatial stream number, cyclic prefix duration, encoding type, or response time.

A method of wireless communication is described. The method may include a memory that stores instructions, a processor coupled with the memory, wherein the processor and the memory are configured to identify, at a transmitting device, an instantaneous value for a reverse link transmission parameter, and transmitting, from the transmitting device to a receiving device, a soliciting frame on a forward link to solicit a solicited frame on a reverse link with the reverse link transmission parameter indicated by the instantaneous value, wherein the soliciting frame includes the instantaneous value for the reverse link transmission parameter.

An apparatus for wireless communication is described. The apparatus may include a memory that stores instructions, a processor coupled with the memory, wherein the processor and the memory are configured to identify, at a transmitting device, an instantaneous value for a reverse link transmission parameter, and means for transmitting, from the transmitting device to a receiving device, a soliciting frame on a forward link to solicit a solicited frame on a reverse link with the reverse link transmission parameter indicated by the instantaneous value, wherein the soliciting frame includes the instantaneous value for the reverse link transmission parameter.

Another apparatus for wireless communication is described. The apparatus may include a processor, memory in electronic communication with the processor, and instructions stored in the memory. The instructions may be operable to cause the processor to a memory that stores instructions, a processor coupled with the memory, wherein the processor and the memory are configured to identify, at a transmitting device, an instantaneous value for a reverse link transmission parameter, and transmit, from the transmitting device to a receiving device, a soliciting frame on a forward link to solicit a solicited frame on a reverse link with the reverse link transmission parameter indicated by the instantaneous value, wherein the soliciting frame includes the instantaneous value for the reverse link transmission parameter.

A non-transitory computer readable medium for wireless communication is described. The non-transitory computer-readable medium may include instructions operable to cause a processor to a memory that stores instructions, a processor coupled with the memory, wherein the processor and the memory are configured to identify, at a transmitting device, an instantaneous value for a reverse link transmission parameter, and transmit, from the transmitting device to a receiving device, a soliciting frame on a forward link to solicit a solicited frame on a reverse link with the reverse link transmission parameter indicated by the instantaneous value, wherein the soliciting frame includes the instantaneous value for the reverse link transmission parameter.

In some examples of the method, apparatus, and non-transitory computer-readable medium described above, the apparatus may be a wireless communication terminal and further comprises an antenna and a transceiver.

In some examples of the method, apparatus, and non-transitory computer-readable medium described above, a presence of one or more indicators in a control field in the soliciting frame may be used to indicate a presence of the instantaneous value for the reverse link transmission parameter in the control field.

In some examples of the method, apparatus, and non-transitory computer-readable medium described above, the control field comprises a link adaptation field, or an immediate response rate field, or a combination thereof.

In some examples of the method, apparatus, and non-transitory computer-readable medium described above, the one or more indicators comprise a MCS value, or a NSS, or a combination thereof.

In some examples of the method, apparatus, and non-transitory computer-readable medium described above, at least one bit in the control field of the soliciting frame may be used to indicate that the instantaneous value for the reverse link transmission parameter may be present in the control field of the soliciting frame.

In some examples of the method, apparatus, and non-transitory computer-readable medium described above, the control field comprises a high efficiency variant of a high throughput control field.

In some examples of the method, apparatus, and non-transitory computer-readable medium described above, the instantaneous value for the reverse link transmission parameter may be indicated in a link adaptation field, or a trigger frame field, or a ROMI field, or a combination thereof.

In some examples of the method, apparatus, and non-transitory computer-readable medium described above, the instantaneous value for the reverse link transmission parameter may be signaled by using at least one redefined bit in the soliciting frame, or by using at least one reserved bit in the soliciting frame, or a combination thereof.

In some examples of the method, apparatus, and non-transitory computer-readable medium described above, the at least one reserved bit in the soliciting frame may be further used to indicate that the instantaneous value for the reverse link transmission parameter may be present in the soliciting frame and may be to be used by the receiving device to transmit the solicited frame in response to the soliciting frame.

In some examples of the method, apparatus, and non-transitory computer-readable medium described above, the processor and the memory may be further configured to identify an interference condition at the transmitting device. Some examples of the method, apparatus, and non-transitory computer-readable medium described above may further include processes, features, means, or instructions for selecting the instantaneous value for the reverse link transmission to be included in the soliciting frame based at least in part on the identified interference condition.

In some examples of the method, apparatus, and non-transitory computer-readable medium described above, the processor and the memory may be further configured to identify a fixed mapping between a first value for a forward link transmission parameter and a second value for the reverse link transmission parameter, the fixed mapping known by the receiving device.

In some examples of the method, apparatus, and non-transitory computer-readable medium described above, the processor and the memory may be further configured to periodically update a map between a plurality of forward link transmission parameters and a plurality of reverse link transmission parameters, wherein the map comprises the fixed mapping. Some examples of the method, apparatus, and non-transitory computer-readable medium described above may further include processes, features, means, or instructions for transmitting the updated map to the receiving device.

In some examples of the method, apparatus, and non-transitory computer-readable medium described above, the processor and the memory configured to transmit the updated map to the receiving device comprises the processor and the memory configured to transmit the updated map in a control field, or in one or more management frames, or a combination thereof.

In some examples of the method, apparatus, and non-transitory computer-readable medium described above, the processor and the memory may be further configured to transmit, from the transmitting device to the receiving device, a second soliciting frame on the forward link with the first value for the forward link transmission parameter and without the instantaneous value for the reverse link transmission parameter, to solicit a second solicited frame on the reverse link according to the second value for the reverse link transmission parameter predetermined by the fixed mapping.

In some examples of the method, apparatus, and non-transitory computer-readable medium described above, the instantaneous value comprises an absolute value, or a relative value that indicates a difference from the second value associated with the fixed mapping known by the receiving device.

In some examples of the method, apparatus, and non-transitory computer-readable medium described above, the instantaneous value may be different than the second value.

In some examples of the method, apparatus, and non-transitory computer-readable medium described above, the processor and the memory may be further configured to detect a condition associated with at least the forward link, or the reverse link, or a combination thereof. Some examples of the method, apparatus, and non-transitory computer-readable medium described above may further include processes, features, means, or instructions for selecting a value for the instantaneous value based at least in part on the detected condition. Some examples of the method, apparatus, and non-transitory computer-readable medium described above may further include processes, features, means, or instructions for determining to include the instantaneous value in the soliciting frame based at least in part on the detected condition.

In some examples of the method, apparatus, and non-transitory computer-readable medium described above, the condition comprises an imbalanced interference condition between the forward link and the reverse link.

In some examples of the method, apparatus, and non-transitory computer-readable medium described above, the processor and the memory may be further configured to receive, from the receiving device, a BA associated with a second value for the reverse link transmission parameter, wherein the second value comprises a first BA rate value. Some examples of the method, apparatus, and non-transitory computer-readable medium described above may further include processes, features, means, or instructions for selecting a first value for the instantaneous value for the reverse link transmission parameter based at least in part on a result of an attempt to decode the received BA.

In some examples of the method, apparatus, and non-transitory computer-readable medium described above, the processor and the memory may be further configured to continue to transmit, to the receiving device, a plurality of soliciting frames that comprise the instantaneous value for the reverse link transmission parameter for a defined number of soliciting frames.

In some examples of the method, apparatus, and non-transitory computer-readable medium described above, the processor and the memory may be further configured to receive, from the receiving device, the solicited frame associated with the instantaneous value, wherein the solicited frame comprises a second BA, and wherein the instantaneous value comprises a second BA rate value. Some examples of the method, apparatus, and non-transitory computer-readable medium described above may further include processes, features, means, or instructions for selecting a second value for the instantaneous value based at least in part on a result of an attempt to decode the received solicited frame. Some examples of the method, apparatus, and non-transitory computer-readable medium described above may further include processes, features, means, or instructions for transmitting, from the transmitting device to the receiving device, a second soliciting frame comprising the second value for the instantaneous value for the reverse link transmission parameter.

In some examples of the method, apparatus, and non-transitory computer-readable medium described above, the soliciting frame comprises a BAR frame. In some examples of the method, apparatus, and non-transitory computer-readable medium described above, the solicited frame comprises a BA.

In some examples of the method, apparatus, and non-transitory computer-readable medium described above, the processor and the memory may be further configured to aggregate the BAR frame that includes the instantaneous value together with a data frame in a same physical layer convergence procedure (PLCP) protocol data unit (PPDU), wherein the soliciting frame comprises the PPDU.

In some examples of the method, apparatus, and non-transitory computer-readable medium described above, the reverse link transmission parameter comprises one of a transmission rate, or a bandwidth channel set, or a transmit power, or a spatial stream number, or a cyclic prefix duration, or an encoding type, or a response time, or a combination thereof.

In some examples of the method, apparatus, and non-transitory computer-readable medium described above, the soliciting frame comprises a PPDU. In some examples of the method, apparatus, and non-transitory computer-readable medium described above, the PPDU comprises one of a single media access control (MAC) protocol data unit (MPDU), or an aggregation of a plurality of MPDUs, or a combination thereof.

### BRIEF DESCRIPTION OF THE DRAWINGS

Aspects of the disclosure are described in reference to the following figures:

FIG. 1 illustrates a wireless local area network (WLAN) for transmission parameter control for immediate response frames configured in accordance with various aspects of the present disclosure;

FIG. 2 illustrates an example of a wireless communications systems that supports transmission parameter control for immediate response frames in accordance with various aspects of the present disclosure;

FIGS. 3A-3C illustrate examples of control fields in soliciting frames that support transmission parameter control for immediate response frames in accordance with various aspects of the present disclosure;

FIGS. 4A-4C illustrate examples of process flows that support transmission parameter control for immediate response frames in accordance with various aspects of the present disclosure;

FIGS. 5-7 show block diagrams of a wireless device that supports transmission parameter control for immediate response frames in accordance with various aspects of the present disclosure;

FIG. 8 illustrates a block diagram of a system including a station (STA) that supports transmission parameter control for immediate response frames in accordance with various aspects of the present disclosure;

FIG. 9 illustrates a block diagram of a system including an access point (AP) that supports transmission parameter control for immediate response frames in accordance with various aspects of the present disclosure; and

FIGS. 10-19 illustrate methods for transmission parameter control for immediate response frames in accordance with various aspects of the present disclosure.

### DETAILED DESCRIPTION

Methods, systems, and apparatuses for transmission parameter control for immediate response frames are described. A transmitting device may transmit soliciting frames to a receiving device on a forward link. In response to the soliciting frames, the receiving device may transmit solicited frames in an immediate response back to the transmitting device on a reverse link. In some examples, the reverse link transmission parameters may be predetermined in a fixed mapping such that one or more values for the reverse link transmission parameters depend on one or more values for the forward link transmission parameters. For example, where the solicited frame is a block acknowledgement (BA) or acknowledgement (ACK) associated with a received data block, the reverse link transmission parameter may be a BA rate that depends on the data rate of the received data block according to some fixed mapping. However, instead of using the predetermined values determined from the fixed mapping, for example, because a solicited frame was not successfully decoded at the transmitting device, the transmitter may indicate an instantaneous value for one or more reverse link transmission parameters when sending the soliciting frame on the forward link. As such, the immediate response rate for a single user transmitter can by dynamically optimized, for example instead of using a fixed rate mapping. In such case, the immediate responses rate for a solicited frame may not depend on the transmission rate of the soliciting frame based on a fixed rate mapping. The transmitting device may indicate an instantaneous value for a reverse link transmission parameter (e.g., an immediate response rate) explicitly or implicitly to a receiving device in a soliciting frame in a control field. The receiving device may infer the presence of the instantaneous value based on the presence of the control field in the soliciting frame. The receiving device, having been provided the instantaneous value with the soliciting frame, may override the predetermined value. In some examples, the predetermined value may have been determined by the receiving device based on the fixed mapping and instead uses the instantaneous value for the parameter when transmitting the solicited frame back to the transmitting device on the reverse link in response to the soliciting frame. The reverse link transmission parameters that may be assigned an instantaneous value, in addition to a transmission rate such as a BA rate, may be any parameter affecting the robustness or signal quality of the reverse link, for example a bandwidth channel set, transmit power, spatial stream number, cyclic prefix duration, encoding type, or response time. In some examples, the instantaneous value may be an absolute value. For example, the instantaneous value may specify a certain BA rate or encoding type. The instantaneous value may also be a relative value that indicates a difference between a predetermined or fixed value. For example, the instantaneous value may specify that the BA rate should be decrease by one level, or by two levels, etc., from the predetermined or fixed value for the transmission parameter.

In some examples, the instantaneous value for a solicited frame as determined by the fixed mapping from the soliciting frame may nonetheless be used by the receiving device if the receiving device determines that a soliciting frame does not include an instantaneous value for the reverse link transmission parameter in the control field. The fixed mapping may be used as a default mechanism to determine the reverse link transmission parameter, such as the immediate response rate, where the instantaneous value may be indicated in the soliciting frame to override the value determined using the fixed mapping.

Within a wireless local area network (WLAN), e.g. a Wi-Fi network, a first wireless device may send a frame to a second wireless device that solicits a frame from the second wireless device. In response, the second wireless device my send the solicited frame back to the first wireless device. For example a transmitting device may send a data frame as a soliciting frame to a receiving device. Having successfully received the data frame, the receiving device may send an ACK back to the transmitting device.

A BA frame may be sent for a block of a data frames, instead of an ACK frame for each data frame, which may improve efficiency for the acknowledgement process. For example the data frame may be a physical layer convergence procedure (PLCP) protocol data unit (PPDU) containing a plurality of media access control (MAC) protocol data units (MPDUs). A single BA frame may be used to transmit acknowledgement information concerning each of the MPDUs in the PPDU. So that BAs may be used, a BA session may be established between transmitting and receiving devices, e.g. an access point (AP) and a station (STA).

A BA may be an immediate BA or a delayed BA. For an immediate BA, a block acknowledgement request (BAR) frame, which may be a soliciting frame, may solicit an immediate BA frame response. With the immediate BA, the BA may be returned from the receiving device to the transmitting device within a short interframe space (SIFS) duration of receiving the BAR frame at the receiving device, within the same transmit opportunity (TXOP) as the soliciting frame. Rather than an immediate BA, a BA may be also be a delayed BA, where the BA is not received within the same TXOP as the soliciting frame, e.g. data frame or BAR frame.

In certain versions of IEEE 802.11, e.g. 802.11ac, the rate at which the BA is transmitted from the receiving device back to the transmitting device on the reverse link, e.g. the BA rate, is fixed at a predetermined rate for a given transmit rate for the soliciting frame. For example, if the BA is sent in a PPDU that is not a high throughput (HT) PPDU (e.g. a non-HT PPDU), then the BA rate that may be used to transmit the solicited frame may be the highest rate in the basic service set (BSS) basic rate set (BSSBasicRateSet) that is less than or equal to the rate used to transmit the soliciting frame. In another example, if the BA is sent in a PPDU that is a HT PPDU, or a very high throughput (VHT) PPDU, then the BA rate that may be used to transmit the solicited frame may be determined by the highest rate in the candidate modulation and coding scheme (MCS) set (CandidateMCSSet), where the rate is determined by the number of spatial streams (NSS) and MCS specified by the CandidateMCSSet, such that the BA rate will be less than or equal to the transmission rate for the soliciting frame.

Using a fixed BA rate as discussed above may be based at least in part on an assumption of symmetric link quality, e.g. that the quality of the forward link and the quality of the reverse link are the same, or substantially similar. This assumption may not necessarily be valid. For example, the wireless devices may experience imbalanced interference, e.g. the interference experienced by the transmitting device may be greater than or less than the interference experienced by the receiving device. One situation where asymmetric or imbalanced interference may occur is where a number of APs are deployed geographically close together along with a large number of STAs accessing these APs. In such a deployment each AP may experience interference from a large number of neighboring APs, especially when APs are deployed at roof level with line of sight channels, while a STA accessing one of the APs may experience a lower level of interference.

In imbalanced interference situations such as these, it may then be desirable for the transmission rates on the forward link and the reverse link to be different. That is, it may be desirable to reduce the transmission rate for one of the forward link, or the reverse link, but not both, to account for the interference. However, where one transmission rate is determined based on the other transmission rate, one of the transmission rates may be inefficiently restricted to a rate less than its experienced interference would otherwise allow. For example, a receiving device may send a BA frame to a transmitting device at a certain BA rate. If the BA is lost, e.g. not successfully received, at the transmitting device due to reverse link interference, then the BA rate will need to be reduced so that the BA may be successfully received. If the BA rate on the reverse link depends on the rate used to transmit the soliciting frame on the forward link, then the forward link transmission rate may be reduced to make the BA rate more robust, even though the condition of the forward link is good and would otherwise allow for a higher transmission rate on the forward link.

Instead of using the fixed or predetermined value for the transmission parameter for the solicited frame on the reverse link in response to the soliciting frame on the forward link, an instantaneous value may be indicated in the soliciting frame and used to set the transmission parameter for the reverse link. For example, an instantaneous value for the BA rate to be used to transmit a BA back to the transmitting device may be indicated to the receiving device in the data frame, or in a BAR frame, or in a frame aggregating another data frame along with the BAR frame. This instantaneous value may be used to override the fixed rate mapping that would otherwise be used. Where no instantaneous value is indicated, the fixed rate mapping may be used. Using an instantaneous value may allow the system to more quickly adapt to interference impacting the reverse link, for example by lowering the reverse link transmission rate, without having to modify transmission parameters for the forward link, for example by reducing the transmission rate.

As noted above, one implementation where instantaneous values for a solicited frame are indicated in a soliciting frame includes indicating instantaneous BA rates in data and/or BAR frames for use by immediate BA frames sent on the reverse link. In this example, the transmitting device, or transmitter, may determine the instantaneous BA rate based on a short-term BA loss. The BA loss may be detected by the transmitting device or reported by the receiving device, or receiver.

Aspects of the disclosure are initially described in the context of a wireless communication system. Specific examples are then described for transmission parameter control for immediate response frames. These and other aspects of the disclosure are further illustrated by and described with reference to apparatus diagrams, system diagrams, and flowcharts that relate to transmission parameter control for immediate response frames.

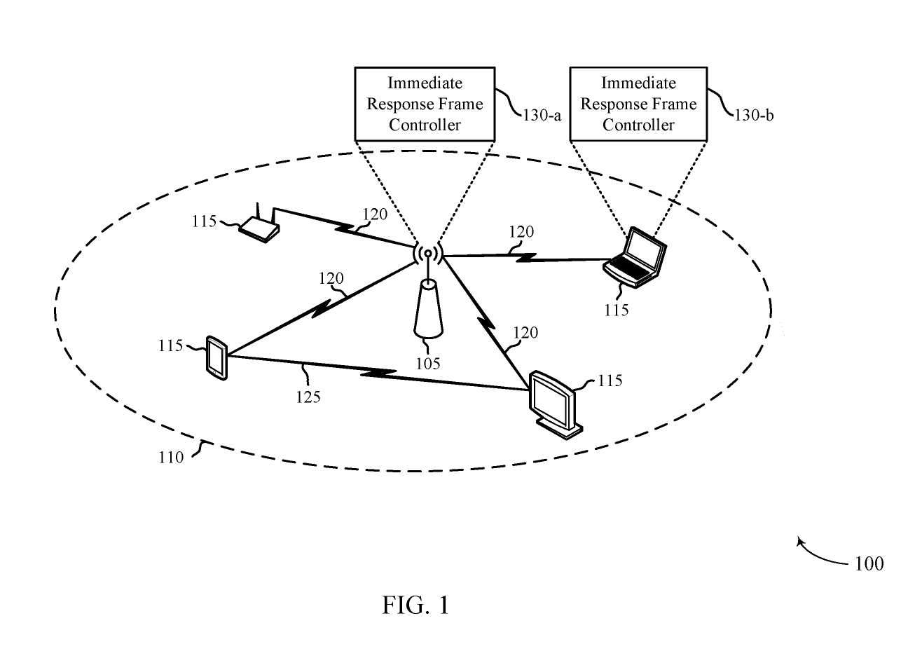

FIG. 1 illustrates a WLAN 100 configured in accordance with various aspects of the present disclosure. The WLAN 100 may include an AP 105 and multiple associated STAs 115, which may represent devices such as mobile stations, phones, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a BSS or an ESS. The various STAs 115 in the network are able to communicate with one another through the AP 105 via wireless links 120. Also shown is a coverage area 110 of the AP 105, which may represent a BSA of the WLAN 100. An extended network station associated with the WLAN 100 may be connected to a wired or wireless distribution system (DS) that may allow multiple APs 105 to be connected in an ESS.

A STA 115 may also be located in the intersection of more than one coverage area 110 and may associate with more than one AP 105. A single AP 105 and an associated set of STAs 115 may be referred to as a BSS. An ESS is a set of connected BSSs. ADS may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100. Devices in wireless communications system 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands.

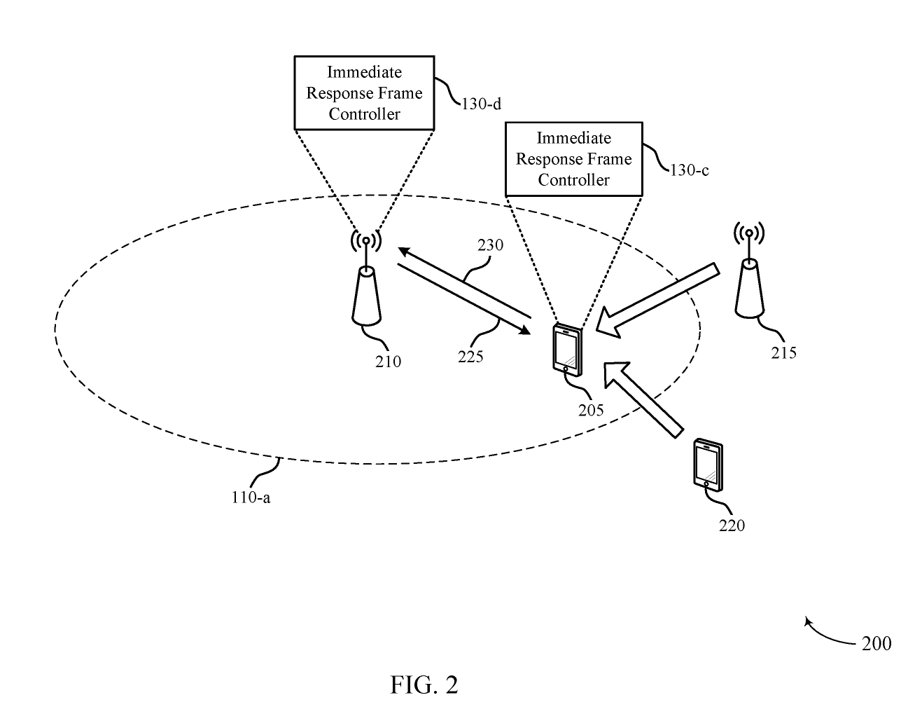

One or both of AP 105 and a STA 115 may also include an immediate response frame controller 130. A transmitting device, which may be either an AP 105, including immediate response frame controller 130-a, or a STA 115, including immediate response frame controller 130-b, may transmit a soliciting frame, e.g. a data frame, a BAR frame, etc., to a receiving device, which may also be either an AP 105 or a STA 115, on a forward link. The receiving device may then transmit an acknowledgement on the reverse link back to the transmitting device. Immediate response frame controller 130 may implement the above-described transmission parameter control for immediate response frames for an AP 105 or STA 115, as well all or portions of the process flows and methods described below with regard to FIGS. 2-19.

For example, immediate response frame controller 130 may identify an instantaneous value for a reverse link transmission parameter and transmit a soliciting frame on a forward link to solicit a solicited frame on a reverse link with the reverse link transmission parameter indicated by the instantaneous value, the soliciting frame including the instantaneous value for the reverse link transmission parameter. Immediate response frame controller 130 may also identify a fixed mapping between a first value for a forward link transmission parameter and a second value for a reverse link transmission parameter, the fixed mapping known by a receiving device. The immediate response frame controller 130 may transmit a soliciting frame on a forward link with the first value and with an instantaneous value for the reverse link transmission parameter, to solicit a solicited frame on a reverse link with the reverse link transmission parameter indicated by the instantaneous value.

In other examples, immediate response frame controller 130 may identify an instantaneous value for a reverse link transmission parameter, and transmit a soliciting frame on a forward link to solicit a solicited frame on a reverse link with the reverse link transmission parameter indicated by the identified instantaneous value, where one or more indicators in a control field in the soliciting frame are used to indicate a presence of the instantaneous value for the reverse link transmission parameter in the control field.

The immediate response frame controller 130 may also transmit a second soliciting frame on the forward link with the first value for the forward link transmission parameter and without the instantaneous value for the reverse link transmission parameter, to solicit a second solicited frame on the reverse link with the first value for the reverse link transmission parameter predetermined by the fixed mapping. In some examples the solicited frame is a BA.

The immediate response frame controller 130 may detect a condition associated with at least the forward link, or the reverse link, or a combination thereof, and may also transmit the instantaneous value based on the detected condition. In some examples the condition is an imbalanced interference condition between the forward link and the reverse link.

The immediate response frame controller 130 may receive a solicited frame BA associated with a BA rate. In some examples the above-described solicited frame may be the BA, and the second value for the reverse link transmission parameter may be the BA rate. The immediate response frame controller 130 may attempt to decode the received BA. The immediate response frame controller 130 may then generate the instantaneous value for the reverse link transmission parameter, for example if the attempt to decode the BA fails. The immediate response frame controller 130 may then decrease the BA rate for a set of BAs until one of the set of BAs may be successfully decoded. In another example, the immediate response frame controller 130 may continue to transmit a set of soliciting frames that include the BA rate for a defined number of soliciting frames.

In some examples the soliciting frame may include a BAR. The immediate response frame controller 130 may aggregate the BAR frame that includes the instantaneous value together with a data frame in a same PPDU, such that the soliciting frame includes the PPDU.

In other examples, the immediate response frame controller 130 may receive a soliciting frame that includes an instantaneous value for a reverse link transmission parameter. The immediate response frame controller 130 may then use the instantaneous value to communicate a solicited frame to a transmitting device using the instantaneous value. The immediate response frame controller 130 may infer the presence of the instantaneous value based at least in part on the presence of a control field in the soliciting frame. In some case, the immediate response frame controller 130 may override a second value for the reverse link transmission parameter that is predetermined based at least in part on a fixed mapping between a first value for a forward link transmission parameter and the second value for the reverse link transmission parameter.

In some examples the instantaneous value for the reverse link transmission parameter may be signaled in at least a control field of the soliciting frame, or by using at least one redefined bit in the soliciting frame, or by using at least one reserved bit in the soliciting frame, or a combination thereof. The control field may be, for example, a link adaptation field, a trigger frame field, a receiver operation mode indication (ROMI) field, or a combination of one or more of such fields. The at least one reserved bit may indicate that the instantaneous value for the reverse link transmission parameter is to be used by the receiving device to transmit the solicited frame in response to the soliciting frame. In other examples at least one reserved bit may be further used to indicate that the instantaneous value for the reverse link transmission parameter is present in the soliciting frame. In some examples the reverse link transmission parameter is a transmission rate. In other examples the reverse link transmission parameter is one of a bandwidth channel set, or a transmit power, or a spatial stream number, or a cyclic prefix duration, or an encoding type, e.g. a low-density parity-check (LDPC) or a proof-carrying code (PCC), etc., or a response time, or a combination thereof. In yet other examples the soliciting frame is a PPDU, where it is one of a single MPDU, or an aggregation of a plurality of MPDUs, or a combination thereof.

FIG. 2 illustrates an example of a wireless communications system 200 that supports transmission parameter control for immediate response frames in accordance with various aspects of the present disclosure. Wireless communications system 200 may include transmitting device 205 in communication with a receiving device 210. Transmitting device 205 may be an example of a STA 115 or an AP 105 described with reference to FIG. 1. Receiving device 210 may also be an example of a STA 115 or an AP 105 described with reference to FIG. 1. For example, transmitting device 205 may be an example of an AP 105, and receiving device 210 may be an example of a STA 115. Or, transmitting device 205 may be an example of a first STA 115 and receiving device 210 may be an example of a second STA 115. Transmitting device 205 includes an immediate response frame controller 130-c, and receiving device 210 includes an immediate response frame controller 130-d, that may implement the above-described transmission parameter control for immediate response frames for an AP 105 or STA 115, as well all or portions of the process flows and methods described below with regard to FIGS. 1 and 3-19.

Immediate response frame controller 130-c at transmitting device 205 may identify an instantaneous value for a reverse link transmission parameter and transmit a soliciting frame on a forward link 230 to solicit a solicited frame on a reverse link 225 from receiving device 210. The reverse link transmission parameter may be indicated by the identified instantaneous value. One or more indicators in a control field in the soliciting frame sent on forward link 230 may be used to indicate a presence of the instantaneous value for the reverse link transmission parameter in the control field to be used on the reverse link 225.

Immediate response frame controller 130-c at receiving device 210 may receive the soliciting frame from the transmitting device 205 on the forward link 230. Receiving device 210 may infer, based at least in part on the presence of a control field in the received soliciting frame, the presence of an instantaneous value for a reverse link transmission parameter to be used by the receiving device 210 to use when transmitting the solicited frame on the reverse link 225.

In some examples, and as further described below, the control field may be a high efficient (HE) variant of a HT control field. In some examples, the control field may be a link adaptation field. In other examples, the control frame may be an immediate response rate field. In still other examples, a trigger frame field may be used. In some examples, a ROMI field may be used.

Other wireless devices, for example STA 220 and/or AP 215 operating in the same or similar frequency bandwidths as transmitting device 205 (e.g., one or both of STA 220 and AP 215 may be a node operating in an other basic service set (OBSS)) may introduce interference at transmitting device 205. Transmitting device 205 may identify an interference condition, and select the instantaneous value for the reverse link transmission to be included in the soliciting frame based at least in part on the interference from STA 220 and/or AP 215.

In some examples, soliciting frames may be uplink (UL) data traffic, and the solicited frames may be BAs. In some configurations, a fixed mapping between the transmission rate for the UL data traffic frames sent on forward link 230 and the BA frames sent on reverse link 225. In some circumstances, for example where there is imbalanced interference in both the forward and reverse directions, the fixed mapping may introduce inefficiencies. In one example, a BA may be lost or unsuccessfully decoded by transmitting device 205 due to interference on the reverse link 225, and a transmission rate on the forward link 230 may be adjusted (e.g., by transmitting device 205) down to a lower rate (e.g., using a lower MCS) so that the BA rate may be more robust, even the forward link 230 is good (e.g., does not experience as much or the same types of interference as experienced on reverse link 225).

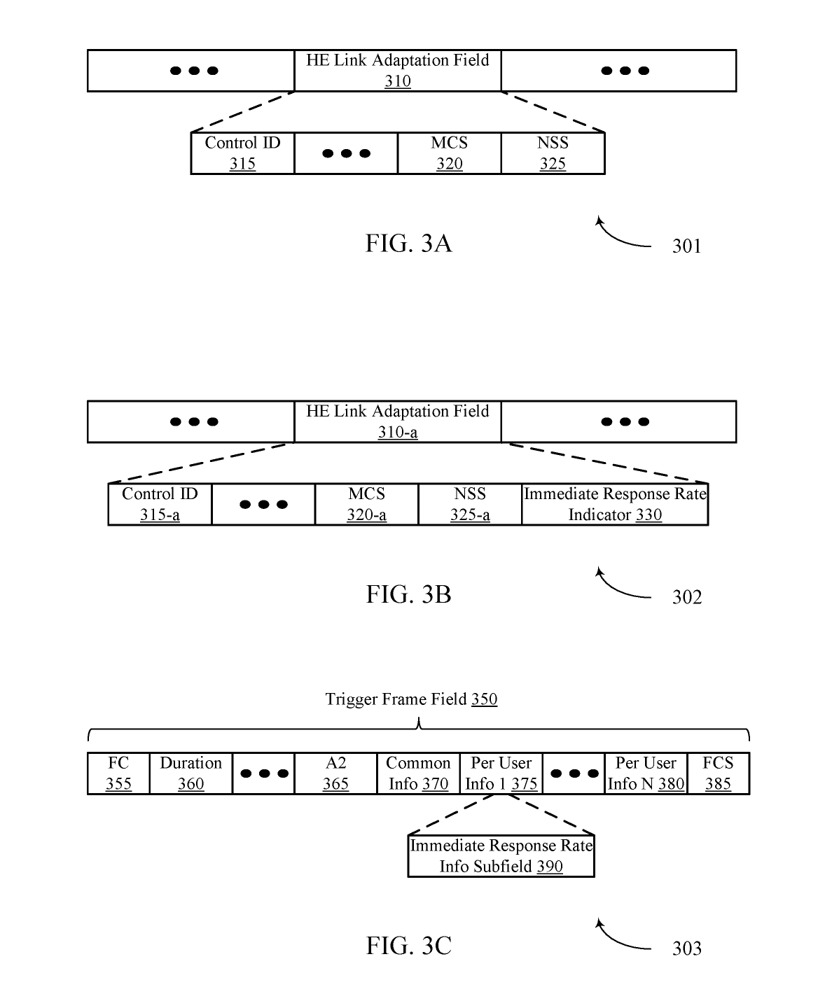

FIGS. 3A-3C illustrate examples of HT control fields in soliciting frames that support transmission parameter control for immediate response frames in accordance with various aspects of the present disclosure. HT control field 301, HT control field 302, and/or HT control field 303 may be transmitted in a soliciting frame by an immediate response frame controller 130 described with reference to FIGS. 1-2, which may be a part of a transmitting device 205, which may be an example of a STA 115 or an AP 105 described with reference to FIGS. 1-2, or by a transmitting device 205 described with reference to FIGS. 2; the soliciting frame may be received by an immediate response frame controller 130 described with reference to FIGS. 1-2 of a receiving device 210, which may be an example of a STA 115 or an AP 105 described with reference to FIGS. 1-2 or a receiving device 210 described with reference to FIG. 2.

FIG. 3A illustrates an example of a HT control field 301 in a soliciting frame that supports transmission parameter control for immediate response frames in accordance with various aspects of the present disclosure. According to this example, HT control field 301 that includes, among other fields, HE link adaptation field 310. HE link adaptation field 310 may include a control ID field 315, a field to indicate a modulation and coding scheme to be used to transmit a solicited frame (MCS field 320), and a field to indicate a number of spatial streams (NSS) to be used to transmit the solicited frame (NSS field 325). Additional fields and/or subfields may also be present in HT control field 301 and/or HE link adaptation field 310. HT control field 301 may be included in a MAC header of the soliciting frame, for example if the soliciting frame is a data frame. In other examples, HT control field 301 may be sent in a soliciting frame that is a dedicated control frame, without data.

A transmitting device 205 may send a soliciting frame for receipt by a receiving device 210 that includes HT control field 301 having a HE link adaptation field 310. The transmitting device may identify an instantaneous value for an immediate response rate that receiving device 210 may use to transmit a solicited frame back to transmitting device 205 in response to the soliciting frame. The instantaneous value may be indicated in HE link adaptation field 310 by a <NSS, MCS> tuple indicated by MCS field 320 and NSS field 325 to send the solicited frame back to transmitting device 205. The receiving device 210 may use the <NSS, MCS> tuple if presented in a HE link adaptation field 310 of a soliciting frame to transmit the solicited frame. If the receiving device 210 determines that HE link adaptation field 310 is not present in the soliciting frame, then receiving device 210 uses the immediate response rate for the solicited frame based on the fixed mapping, if such fixed mapping exists. If no such fixed mapping exists, receiving device 210 can determine the response rate based on the network allocation vector (NAV) duration constraint indicated in the soliciting frame such that the response rate is constrained so that the length of the solicited frame does not violate the NAV duration constraint. In some examples, the immediate response rate for the solicited frame that the receiving device 210 would use to transmit a solicited frame in response to a soliciting frame based on the fixed mapping may be overridden by the immediate response rate indicated by the <NSS, MCS> tuple if presented in a HE link adaptation field 310 of the soliciting frame.

In some examples, a receiving device 210 may apply a certain rate backoff to the immediate control response rate indicated in HT control field 301 when transmitting a solicited frame with certain frame types back to transmitting device 205 in response to the soliciting frame. For example, for a certain <NSS, MCS> tuple presented in a HE link adaptation field 310, receiving device 210 may reduce the MCS and/or NSS by a certain number of values according to a certain rule if the solicited frame is a BA frame. The rate backoff for each frame type can be determined based on standards or negotiated between soliciting and solicited nodes (e.g. a transmitting device 205 and a receiving device 210) in advance.

One or more of the above described examples may provide simplicity by reusing fields in a HE link adaptation field 310, rather than defining additional fields and/or subfields.

FIG. 3B illustrates an example of a HT control field 302 in a soliciting frame that supports transmission parameter control for immediate response frames in accordance with various aspects of the present disclosure. According to this example, HT control field 302 includes, among other fields, HE link adaptation field 310-a. HE link adaptation field 310-a may include a control ID field 315-a, a field to indicate a modulation and coding scheme to be used to transmit a solicited frame (MCS field 320-a), a field to indicate a number of spatial streams (NSS) to be used to transmit the solicited frame (NSS field 325-a), and an immediate response rate indicator field 330. Additional fields and/or subfields may also be present in HT control field 302 and/or HE link adaptation field 310-a.

A transmitting device 205 may identify an instantaneous value for an immediate response rate that receiving device 210 may use to transmit a solicited frame back to transmitting device 205 in response to the soliciting frame in HE link adaptation field 310 by a <NSS, MCS> tuple indicated by MCS field 320 and NSS field 325. The receiving device 210 may use the <NSS, MCS> tuple is presented in a HE link adaptation field 310 of a soliciting frame to transmit the solicited frame. Immediate response rate indicator field 330 may be used to indicate whether the receiving device 210 is to use the provided <NSS, MCS> tuple to transmit the solicited frame. If the immediate response rate indicator field 330 indicates the provided <NSS, MCS> tuple is not for immediate response rate, then receiving device 210 may use the immediate response rate for the solicited frame based on the fixed mapping if such fixed mapping exists. If no such fixed mapping exists, receiving device 210 can determine the response rate based on the NAV duration constraint indicated in the soliciting frame such that the response rate is constrained so that the length of the solicited frame does not violate the NAV duration constraint. In some examples, the immediate response rate indicator field 330 may be a single bit, where a value of 1 may indicate that the receiving device is to use the immediate response rate for the solicited frame as communicated by the <NSS, MCS> tuple, and a 0 may indicate that the provided <NSS, MCS> tuple is not for immediate response rate of the solicited frame. If it is not for immediate response rate, the <NSS, MCS> tuple may be used as a suggested rate for future new transmissions initiated by the receiving device 210 to the transmitting device 205.

In some examples, providing an explicit indication of whether to use the tuple or a fixed mapping in an immediate response rate indicator field 330 may provide further flexibility to the transmitting device 205 to indicate an immediate response rate. For example, the transmitting device 205 that solicits the solicited frame (e.g., an immediate response frame), may want the solicited frame to be sent with a more conservative rate than the suggested rate for future new transmissions initiated by the receiving device 210 to the transmitting device 205.

FIG. 3C illustrates an example of a HT control field 303 in a soliciting frame that supports transmission parameter control for immediate response frames in accordance with various aspects of the present disclosure. According to this example, HT control field 303 is a trigger frame field 350 that includes, among other fields, a frame control field (FC field 355), duration field 360, one or more address fields, including A2 field 365 associated with a receiving device for the HT control field 303, a common information field 370, a number of per user information fields for N users, including a first per user information field 375 through an Nth per user information field 380, and a frame check sequence field 385. One or more of the per user field may include an immediate response rate information subfield 390, among other fields that may be present within the per user field. Additional fields and/or subfields may also be present in trigger frame field 350, for example a field indicating a transmitter address, or addresses for other wireless devices associated with the per user information.

The immediate response rate information subfield 390 may include an immediate response rate for the receiving device 210 to use when transmitting a solicited frame in response to a soliciting frame. In some examples, the transmitting device 205 may be a station, such that an address associated with a receiving device 210 (e.g., an AP) may be indicated in the trigger frame field 350, for example in A2 field 365, or another address field of trigger frame field 350. In other examples, certain of the fields in the trigger frame field 350 may not be used by the receiving device 210 that receives a soliciting frame from the transmitting device 205 in case that the communications only involve transmitting device 205 and receiving device 210, for example the frequency resource unit allocation information in each of first per user information field 375 through the Nth per user information field 380. A new trigger type can be defined to trigger response in single user (SU) communications without carrying such unnecessary info. Specifically, a new value (e.g., SU trigger type) can be introduced for the existing trigger type in common information field 370. The trigger frame field in SU type may have different or simplified format from the trigger frame field 350 but may carry the SU immediate response rate information (e.g., <NSS, MCS> tuple) for the immediate solicited frame. The SU immediate response rate (e.g., <NSS, MCS> tuple) may be carried in common information field 370 without the remaining per user information fields. Or the immediate response rate can be carried in simplified per user information field, which may have a user ID and immediate response rate information.

Trigger frame field 350 may be included in a MAC header of a soliciting frame, for example if the soliciting frame is a data frame. In other examples, HT control field 303 may be sent in a soliciting frame that is a dedicated control frame, without such data.

In some examples, receiving device 210 may use the immediate response rate communicated to receiving device 210 by the transmitting device 205 in HT control field 301 or HT control field 302 of a soliciting frame where a reference payload size is less than a predetermined threshold. In some examples, where the receiving device 210 determines that the payload size exceeds the predetermined threshold, the receiving device 210 may send the solicited frame using an immediate response rate selected by the receiving device 210. According to another example, the receiving device 210 may use the immediate response rate indicated by a fixed mapping from the soliciting frame when the payload size exceeds the predetermined threshold. If the payload size does not exceed the predetermined threshold, the receiving device 210 may use the provided <MCS, NSS> tuple as the immediate response rate of the solicited frame. The reference payload size may be indicated in a field of HT control field 301 and/or HT control field 302, for example in a field of HE link adaptation field 310.

In other examples, a HT control field to convey the immediate response rate may be a ROMI field. The ROMI field may be a type of HE variant of HT control field and may be used by the transmitting device 205 to communicate the immediate response rate or an indicator of the immediate response rate to a receiving device 210 for the receiving device 210 to use in transmitting a solicited frame back to the transmitting device 205. However, a ROMI field may contain a number of fields that may be unused, and thus irrelevant to the receiving device. For example, the ROMI field may include a receiver bandwidth (RXBW) field and/or receiver number of spatial streams (RXNSS) field that may not be used by the receiving device 210.

In other examples, a fixed rate mapping may be updated to respond to interference or other channel conditions experienced by the receiving device 210 and/or transmitting device 205. For example, the receiving device 210 may use a fixed mapping to determine a transmission rate for the solicited frame from the transmission rate for the soliciting frame. However, the fixed mapping may be updated whether periodically or according to another schedule, to respond to interference or other channel conditions.

In some examples, the fixed rate mapping may be updated by the transmitting device 205, and the fixed mapping communicated to receiving device 210 in a HT control field, for example a HE HT control field. The HT control field having the updated fixed mapping may be sent as a dedicated control frame, or in the MAC header of a data frame. Upon receiving the updated fixed mapping, receiving device 210 may determine the transmission rate for solicited frames based on the transmission rate of a soliciting frame based on the updated fixed mapping, for example until a next updated fixed mapping is received.

In some examples, the fixed rate mapping may be updated by the transmitting device 205, and the fixed mapping communicated to receiving device 210 through the use of one or more management frame exchanges. For example transmitting device 205 may send one or more rate mapping setup and/or teardown messages to receiving device 210 to communicate the updated fixed mapping.

In some examples, the fixed mapping may be updated more or less frequently, for example based on a determination that the channel conditions are changes more or less quickly. For example, a transmitting device 205 may determine a rate of change of interference or other channel conditions, and update the fixed mapping more frequently for a larger rate of change, or less frequently for a smaller rate of change.

A receiving device 210 that receives a HT control field 301, HT control field 302, or HT control field 303 may determine the transmission rate that it will use for the solicited frame from the explicit signaling in such control frame. In other examples, the soliciting frame may not contain explicit signaling, and the receiving device 210 may deduce the transmission rate to be used for the solicited frame based on the length or duration of an indicated NAV. For example, the receiving device 210 may determine a lowest MCS that fills the NAV, without exceeding the NAV. In some examples, the receiving device 210 may use the lowest MCS to fill the NAV for a single frame exchange within a single TXOP, but determine a higher MCS for multiple frame exchanges within a single TXOP.

According to some examples, the immediate response rate indicated by the soliciting frame may be a suggested rate. The receiving device 210 may determine to select an immediate response rate that complies within the NAV. In other examples, the receiving device 210 may determine instead to select an immediate response rate for the solicited frame that does not comply with the NAV duration. In some examples, the soliciting frame may not contain an explicit indication of the immediate response rate, and the receiving device may determine an immediate response rate based on the length of the NAV, for example the lowest MCS that does not exceed the NAV, or the lowest immediate response rate that does not violate the NAV. The receiving device 210 may be preconfigured such that it selects the immediate response rate to not violate the NAV. In other examples, the receiving device 210 may not be so preconfigured, such that it may violate the NAV duration when transmitting the solicited frame to the transmitting device 205.

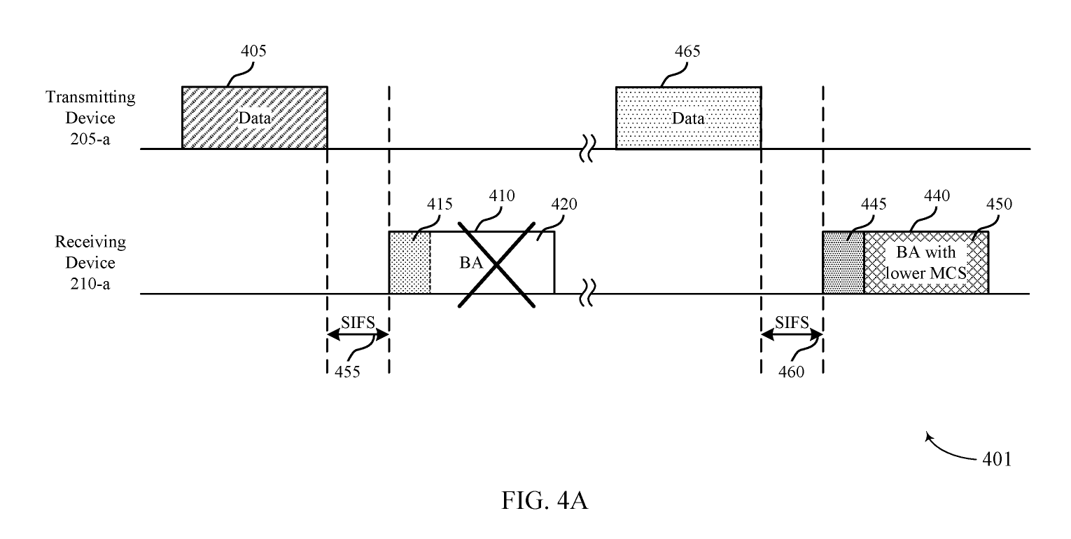

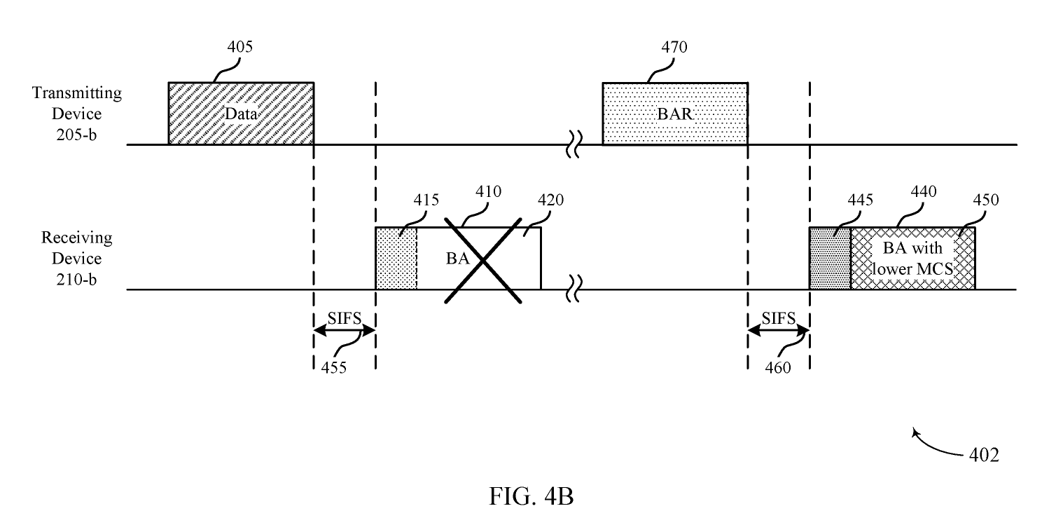

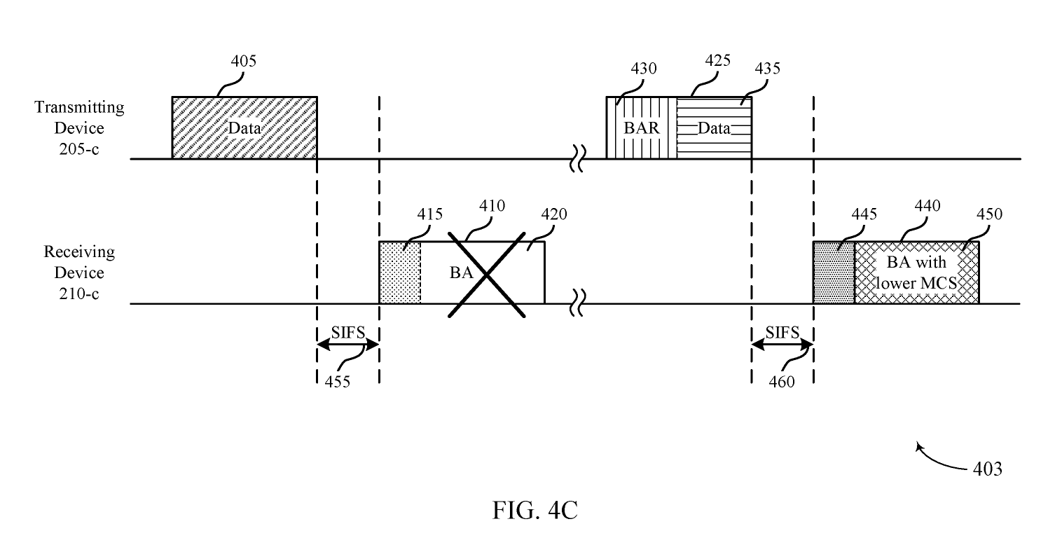

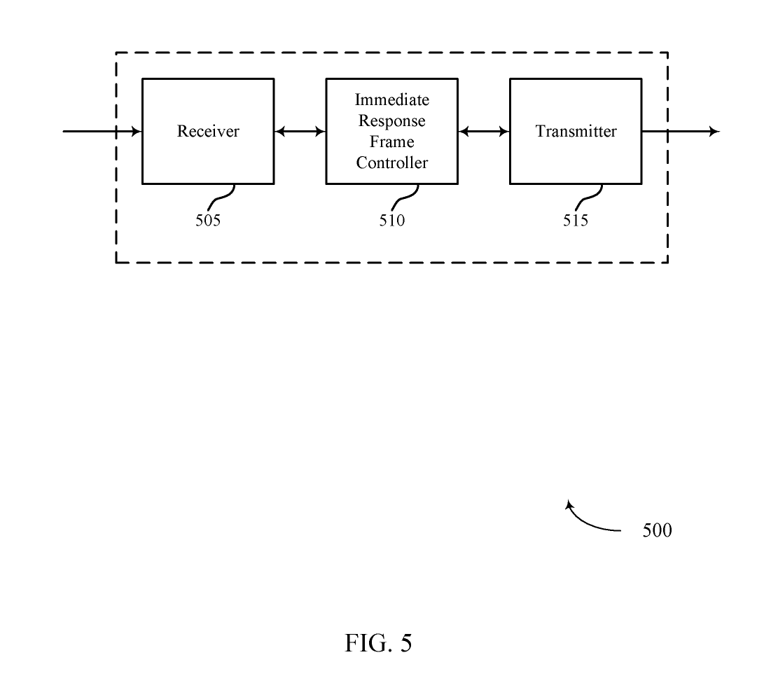

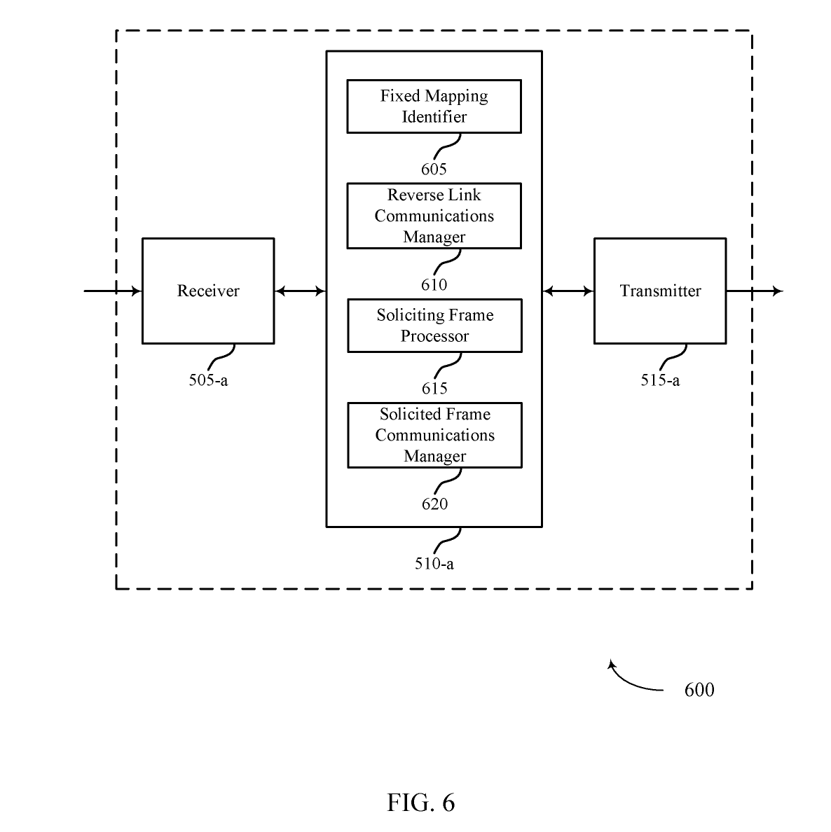

FIG. 4A illustrates an example of a process flow 401 that supports transmission parameter control for immediate response frames in accordance with various aspects of the present disclosure. Process flow 401 may be performed by transmitting device 205-a in communication with a receiving device 210-a. Transmitting device 205-a may be an example of a STA 115 or an AP 105 described with reference to FIGS. 1-2. Receiving device 210-a may also be an example of a STA 115 or an AP 105 described with reference to FIGS. 1-2. For example, transmitting device 205-a may be an example of an AP 105, and receiving device 210-a may be an example of a STA 115. Or, transmitting device 205-a may be an example of a first STA 115 and receiving device 210-a may be an example of a second STA 115.

Process flow 401 illustrates that transmitting device 205-a may send a data frame 405, or another soliciting frame in other examples, to receiving device 210-a. As discussed above, data frame 405 may be a PPDU, including multiple MPDUs, and transmitting device 205-a and receiving device 210-a may have previously established a BA session to allow for the use of BAs to be sent according to a fixed mapping between a transmission parameter for the forward link and a transmission parameter for the reverse link, as discussed further above. After SIFS 455, a BA 410, or other solicited frame in other examples, may be sent by receiving device 210-a in response to data frame 405. BA 410 may have a BA payload 420 that includes acknowledgements for the block of data sent in data frame 405, and include a BA preamble 415. Transmitting device 205-a may successfully decode the BA preamble 415, but fail to successfully decode the BA payload 420, for example because BA preamble 415 is sent at a lower transmission rate than BA payload 420.

After failing to successfully decode the BA payload 420, the transmitting device 205-a may generate an instantaneous value for the BA rate to be included with the retransmitted data frame, data frame 465. The instantaneous value may be the BA rate previously used to transmit BA 410, but reduced to a lower BA rate. In some examples, the BA rate may be based on a certain MCS, and the lower BA rate may be based on a lower MCS. Data frame 465 may then be retransmitted. After SIFS 460, a BA 440, or another solicited frame in other examples, may be sent by receiving device 210-a in response to data frame 465, where BA 440 may have a BA payload 450 that includes acknowledgements, encoded according to the instantaneous value for the BA rate, for the blocks of data sent in data frame 465, and also includes a BA preamble 445. Transmitting device 205-a may successfully decode both BA preamble 445 and BA payload 450 now that BA payload 450 is encoded at a lower BA rate.

In some examples, after data frame 465 is sent with an indication of an instantaneous value, if the BA payload 450 of BA 440 fails to be decoded by transmitting device 205-a, an indication of an even lower instantaneous values for the BA rate may be included with a subsequently-retransmitted data frame. Transmitting device 205-a may continue to incrementally decrease the BA rate, or other transmission parameter, indicated in subsequently-retransmitted data frames until a received BA payload associated with the data is successfully decoded. For example, each subsequently-retransmitted data frame may indicate a BA rate that is lowered by one additional level, by reducing the MCS level by one. In another example, the transmitting device may monitor and measure reference signals to predict the number of levels by which the BA rate may need to be reduced in order to successfully decode the BA payload.

In some examples, after data frame 465 is sent with an indication of an instantaneous value, and BA 440, encoded at receiving device 210-a based on the instantaneous value, is successfully decoded at transmitting device 205-a, the transmitting device 205-a may continue to transmit the indication of the instantaneous value in data frames for a predetermined number of data frames. After the predetermined number of data frames have been transmitted, the transmitting device 205-a may revert to allowing the receiving device 210-a to use the predetermined transmission rate, determined from the fixed mapping.

In other examples, the transmitting device 205-a may modify other parameters, such a bandwidth channel set, transmit power, spatial stream number, cyclic prefix duration, encoding type, or response time in response to the failure to decode the BA payload 420. Transmitting device 205-a may modify these parameters in order to make the transmission of BAs on the reverse link more robust in the presence of interference so that there is an increased likelihood that transmitting device 205-a will successfully decode the received BAs.

FIG. 4B illustrates an example of a process flow 402 that supports transmission parameter control for immediate response frames in accordance with various aspects of the present disclosure. Process flow 402 may be performed by transmitting device 205-b in communication with a receiving device 210-b. Transmitting device 205-b may be an example of a STA 115 or an AP 105 described with reference to FIGS. 1-2, or a transmitting device 205 described with reference to FIGS. 2-4B. Receiving device 210-b may also be an example of a STA 115 or an AP 105 described with reference to FIGS. 1-2, or a receiving device 210 described with reference to FIGS. 2-4B.

Similar to process flow 401, process flow illustrates that transmitting device 205-b may send a data frame 405, or another soliciting frame in other examples, to receiving device 210-b. After SIFS 455, BA 410, or other solicited frame in other examples, may be sent by receiving device 210-b in response to data frame 405. Transmitting device 205-b may successfully decode the BA preamble 415, but fail to successfully decode the BA payload 420. In response to this failure, transmitting device 205-b will generate an instantaneous value for the BA rate to be communicated to the receiving device 210-b. However, instead of retransmitting the indication in a retransmitted data frame, transmitting device 205-b may include the instantaneous value in BAR 470 to request that the BA be retransmitted by the receiving device 210-b. Then, after SIFS 460, a BA 440 that includes a BA preamble 445 and BA payload 450 with a reduced BA rate, for example a lower MCS, may be sent by receiving device 210-b in response to BAR 470.

Similar to the process described above with regard to process flow 401 with regard to a retransmitted data frame, transmitting device 205-b may continue to incrementally decrease the BA rate, or other instantaneous value for a transmission parameter, by transmitting additional BARs. These BARs may be subsequently retransmitted by receiving device 210-b until a BA payload associated with data frame 405 is successfully decoded by transmitting device 205-b.

In another example, the instantaneous value for the transmission parameter indicated in BAR 470 may be used by receiving device 210 for a predetermined number of data frames after the BA payload associated with BAR 470 is successfully decoded.

FIG. 4C illustrates an example of a process flow 403 that supports transmission parameter control for immediate response frames in accordance with various aspects of the present disclosure. Process flow 403 may be performed by transmitting device 205-c in communication with a receiving device 210-c. Transmitting device 205-c may be an example of a STA 115 or an AP 105 described with reference to FIGS. 1-2, or a transmitting device 205 described with reference to FIGS. 2-4B. Receiving device 210-c may also be an example of a STA 115 or an AP 105 described with reference to FIGS. 1-2, or a receiving device 210 described with reference to FIGS. 2-4B.

Similar to process flow 300, process flow illustrates that transmitting device 205-c may send a data frame 405 to receiving device 210-c. After SIFS 455, BA 410, or other solicited frame in other examples, may be sent by receiving device 210-c in response to data frame 405. Transmitting device 205-c may successfully decode the BA preamble 415, but fail to successfully decode the BA payload 420. In response to this failure, transmitting device 205-c will generate an instantaneous value for the BA rate to be communicated to the receiving device 210-c. However, instead of retransmitting the indication in a retransmitted data frame or BAR frame, transmitting device 205-c may aggregate the BAR frame 430 that includes the instantaneous value together with a data frame 435 together in a same data unit 425, which in some examples may be a PPDU. Then, after SIFS 460, a BA 440 that includes a BA preamble 445 and BA payload 450 with a reduced BA rate, for example a lower MCS, may be sent by receiving device 210-c in response to BAR frame 430, while the data frame 435 may be received by receiving device 210-c. Aggregating the BAR frame 430 together with the data frame 435 may increase transmission efficiency.

In FIGS. 4A-4C, an instantaneous value for a reverse link transmission parameter may be indicated in a soliciting frame sent by transmitting device 205 to a receiving device 210. There are different ways to signal the instantaneous value in the soliciting frame in accordance with various aspects of the present disclosure.

In a first example, the instantaneous value may be signaled in an existing feedback field in a HT control field that is carried by the soliciting frame. For example, this feedback field may be a modulation and coding scheme (MCS) feedback field. The MCS feedback may indicate the MCS, a number of space time streams (N_STS) (e.g., a NSS), and a bandwidth. If the soliciting frame is a BAR frame, then the feedback field may be included in a control wrapper frame where the HT control field has been added to the control wrapper frame. The receiving device, upon receiving the soliciting frame, will then use the instantaneous value determined from the feedback field. Where the feedback field is an MCS feedback field indicating a BA rate, the solicited frame may be a BA frame using the instantaneous value associated with the BA rate from the MCS feedback field.

The approach of the first example may introduce ambiguity where it may be unclear whether the feedback field in the control field relates to the rate setting for the future data frame, or to the solicited frame, e.g. a BA frame. The MCS feedback may provide a recommended rate for the transmission of data frames, which may be determined based at least in part on criterion that may not be applicable to the solicited frame, for example maximizing throughput or goodput, but not keeping the packet error rate (PER) of the transmitted data frames below a target value.

In a second example, the feedback field in the control field as in the first example may be used, except that a single bit in the soliciting frame may be used to explicitly indicate that the feedback in the feedback field is to be used for transmitting the solicited frame on the reverse link. In one example, the feedback in the feedback field may be MCS feedback in an MCS feedback field. The bit to be used may include any reserved bit in the HT control field, for example B25-B28 in the HT variant HT control field, or B1 in the very high throughput (VHT) variant HT control field. Where the soliciting frame is a BAR frame, the bit to be used may be any reserved bit in the BAR, for example B3-B11 in the BAR control field, or B0-B3 in a starting sequence control (SSC) field. Where the receiving device determines that the single bit as described above is present in a soliciting field, the receiving device will then use the instantaneous value as determined by looking to the feedback field as in the first example, rather than the predetermined value determined by the fixed mapping, when transmitting the solicited frame. Where the feedback field is an MCS feedback field indicating a BA rate, the solicited frame may be a BA frame using the instantaneous value associated with the BA rate from the MCS feedback field.

In a third example, a dedicated field to provide feedback to communicate the instantaneous value can be added. For example, an immediate response rate field with a new control field ID may be added to a high efficiency variant of a HT control field. This third example may also eliminate ambiguity as discussed above with reference to the first and second examples, and operates similarly to using a reserved bit to indicate the presence of an instantaneous value in the soliciting frame for the receiving device to use when sending a solicited frame.

In a fourth example, existing fields may be redefined or reserved bits used in the soliciting frame to signal that an instantaneous value is in the soliciting frame. In one example, the bits to be redefined may be one or more bits from the transmitter address (TA), receiver address (RA), scrambling seed in the service field, frame control field, or a combination of such bits. In other examples, reserved bits may be used. Such reserved bits may be one or more bits from a signal (SIG) field or service field. When the soliciting frame is a BAR frame, the bit to be used may be any reserved bit in the BAR, for example B3-B11 in the BAR control field, or B0-B3 in a SSC field. An indicator may also be introduced to indicate the presence of an instantaneous value that is communicated with the above redefined and/or reserved bits, for example a reserved bit may be set to “1” or a redefined bit that was “0” may be set to “1”. If the receiving device detects an indicator bit to indicate the presence of an instantaneous value, then the receiving device determines the instantaneous value and overrides its predetermined value based on the fixed mapping.

FIG. 5 shows a block diagram of a wireless device 500 configured for transmission parameter control for immediate response frames in accordance with various aspects of the present disclosure. Wireless device 500 may be an example of aspects of a STA 115 described with reference to FIGS. 1-4. Wireless device 500 may include a receiver 505, an immediate response frame controller 510, or a transmitter 515. Wireless device 500 may also include one or more processors, memory coupled with the one or more processors, and instructions stored in the memory that are executable by the one or more processors to enable the one or more processors to perform the roaming features discussed herein. Each of these components may be in communication with each other

The receiver 505 may receive information such as packets, user data, or control information associated with various information channels (e.g., control channels, data channels, and information related to transmission parameter control for immediate response frames, etc.). Information may be passed on to the immediate response frame controller 510, and to other components of wireless device 500.

The immediate response frame controller 510 may identify a fixed mapping between a first value for a forward link transmission parameter and a second value for a reverse link transmission parameter, the fixed mapping known by a receiving device, and transmit, from a transmitting device to the receiving device, a soliciting frame on a forward link with the first value and with an instantaneous value for the reverse link transmission parameter, to solicit a solicited frame on a reverse link with the reverse link transmission parameter indicated by the instantaneous value. The immediate response frame controller 510 may also identify an instantaneous value for a reverse link transmission parameter and transmit, from the transmitting device to a receiving device, a soliciting frame on a forward link to solicit a solicited frame on a reverse link with the reverse link transmission parameter indicated by the identified instantaneous value, where one or more indicators in a control field in the soliciting frame are used to indicate a presence of the instantaneous value for the reverse link transmission parameter in the control field.

The transmitter 515 may transmit signals received from other components of wireless device 500. In some examples, the transmitter 515 may be collocated with the receiver 505 in a transceiver module. The transmitter 515 may include a single antenna, or it may include a plurality of antennas.

FIG. 6 shows a block diagram of a wireless device 600 for transmission parameter control for immediate response frames in accordance with various aspects of the present disclosure. Wireless device 600 may be an example of aspects of a wireless device 500 or a STA 115 described with reference to FIGS. 1-5. Wireless device 600 may include a receiver 505-a, an immediate response frame controller 510-a, or a transmitter 515-a. Wireless device 600 may also include a processor. Each of these components may be in communication with each other. The immediate response frame controller 510-a may also include a fixed mapping identifier 605, a reverse link communications manager 610, a soliciting frame processor 615, and a solicited frame communications manager 620.

The receiver 505-a may receive information which may be passed on to immediate response frame controller 510-a, and to other components of wireless device 600. The immediate response frame controller 510-a may perform the operations described with reference to FIG. 5. The transmitter 515-a may transmit signals received from other components of wireless device 600.

The fixed mapping identifier 605 may identify a fixed mapping between a first value for a forward link transmission parameter and a second value for a reverse link transmission parameter, the fixed mapping known by a receiving device as described with reference to FIGS. 1-4. The fixed mapping identifier 605 may also identify a fixed mapping between a first value for a forward link transmission parameter and a second value for the reverse link transmission parameter, the fixed mapping known by the receiving device, with the instantaneous value to override the second value for the reverse link transmission parameter at the receiving device.

The reverse link communications manager 610 may transmit, from a transmitting device to the receiving device, a soliciting frame on a forward link with the first value and with an instantaneous value for the reverse link transmission parameter, to solicit a solicited frame on a reverse link with the reverse link transmission parameter indicated by the instantaneous value as described with reference to FIGS. 1-4. The reverse link communications manager 610 may also transmit a second soliciting frame on the forward link with the first value for the forward link transmission parameter and without the instantaneous value for the reverse link transmission parameter, to solicit a second solicited frame on the reverse link with the first value for the reverse link transmission parameter predetermined by the fixed mapping. In some examples, the solicited frame may be a BA. The reverse link communications manager 610 may also may also identify an instantaneous value for a reverse link transmission parameter and transmit, from the transmitting device to a receiving device, a soliciting frame on a forward link to solicit a solicited frame on a reverse link with the reverse link transmission parameter indicated by the identified instantaneous value, where one or more indicators in a control field in the soliciting frame are used to indicate a presence of the instantaneous value for the reverse link transmission parameter in the control field. The control field may be a high efficiency variant of a high throughput control field, and the control field may be a link adaptation field, or an immediate response rate field, or a trigger frame field, or a ROMI field, or a combination thereof. The trigger frame field may have a trigger type of a single user trigger, or a basic trigger, or a combination thereof. The one or more indicators may also be a MCS value, or a NSS, or a combination thereof. In some examples, at least one bit in the control field is used to indicate that the instantaneous value for the reverse link transmission parameter is present in the control field of the soliciting frame. The reverse link communications manager 610 may also generate the instantaneous value for the reverse link transmission parameter. The reverse link communications manager 610 may also decrease the BA rate for a plurality of BAs until one of the plurality of BAs is successfully decoded. The reverse link communications manager 610 may also continue to transmit a plurality of soliciting frames that include the BA rate for a defined number of soliciting frames. In some examples, the soliciting frame may be a BAR. The reverse link communications manager 610 may also aggregate the BAR frame that includes the instantaneous value together with a data frame in a same PPDU, wherein the soliciting frame includes the PPDU. In some examples, the instantaneous value for the reverse link transmission parameter may be signaled in at least a control field of the soliciting frame, or by using a redefined bit in the soliciting frame, or by using a reserved bit in the soliciting frame, or a combination thereof. In some examples, the soliciting frame may be a PPDU. In some examples, the PPDU may be one of a single MPDU, or an aggregation of a plurality of MPDUs, or a combination thereof.

The soliciting frame processor 615 may receive a soliciting frame with an instantaneous value for a reverse link transmission parameter to be used by the receiving device to communicate a solicited frame to a transmitting device as described with reference to FIGS. 1-4. The soliciting frame processor 615 may also receive, at a receiving device, a soliciting frame that includes an instantaneous value for a reverse link transmission parameter to be used by the receiving device to communicate a solicited frame to a transmitting device, and infer a presence of the instantaneous value based at least in part on the presence of a control field in the soliciting frame. The soliciting frame processor 615 may also determine that the instantaneous value for the reverse link transmission parameter is in the soliciting frame based at least in part on an at least one bit indication in the control field of the soliciting frame. In some examples the instantaneous value for the reverse link transmission parameter is indicated in a link adaptation field, or a trigger frame field, or a ROMI field, or a combination thereof. The soliciting frame processor 615 may also determine a MCS value for the solicited frame based at least in part on the NAV duration, wherein the instantaneous value for the reverse link transmission parameter comprises a NAV duration. In some examples, the MCS value is determined to be a lowest MCS value that fills the NAV duration. The soliciting frame processor 615 may also receive a second soliciting frame that includes a second instantaneous value for the reverse link transmission parameter and includes a NAV duration. In some examples, the soliciting frame may be a block acknowledgement request (BAR) that includes the instantaneous value for the reverse link transmission parameter. In some examples, the soliciting frame may include a BAR aggregated together with a data frame in a same PPDU, wherein the BAR includes the instantaneous value for the reverse link transmission parameter. The soliciting frame processor 615 may also receive a reserved bit to indicate that the instantaneous value is to be used by the receiving device to transmit the solicited frame to the transmitting device. The soliciting frame processor 615 may also receive a reserved bit to indicate that the instantaneous value for the reverse link transmission parameter is present in the soliciting frame. In some examples, the soliciting frame may be a PPDU. In some examples, the PPDU may be one of a single MPDU, or an aggregation of a plurality of MPDUs, or a combination thereof.

The solicited frame communications manager 620 may override, based at least in part on the received instantaneous value, a second value for the reverse link transmission parameter based at least in part on a first value for a forward link transmission parameter as described with reference to FIGS. 1-4. The solicited frame communications manager 620 may also transmit the solicited frame to the transmitting device using the instantaneous value for the reverse link transmission parameter. The solicited frame communications manager 620 may also override, based at least in part on the instantaneous value, a second value for the reverse link transmission parameter, where the second value is predetermined based at least in part on a fixed mapping between a first value for a forward link transmission parameter and the second value for the reverse link transmission parameter. The solicited frame communications manager 620 may also determine, based at least in part on a NAV duration, to comply with a second instantaneous value when transmitting a second solicited frame in response to the second soliciting frame. The solicited frame communications manager 620 may also override, based at least in part on the NAV duration, the second instantaneous value when transmitting a second solicited frame in response to the second soliciting frame. In some examples, the solicited frame may be a BA and the soliciting frame may be a BAR. In some examples, the reverse link transmission parameter may be a transmission rate. In some examples, the reverse link transmission parameter may be one of a bandwidth channel set, or a transmit power, or a spatial stream number, or a cyclic prefix duration, or an encoding type, or a response time, or a combination thereof.

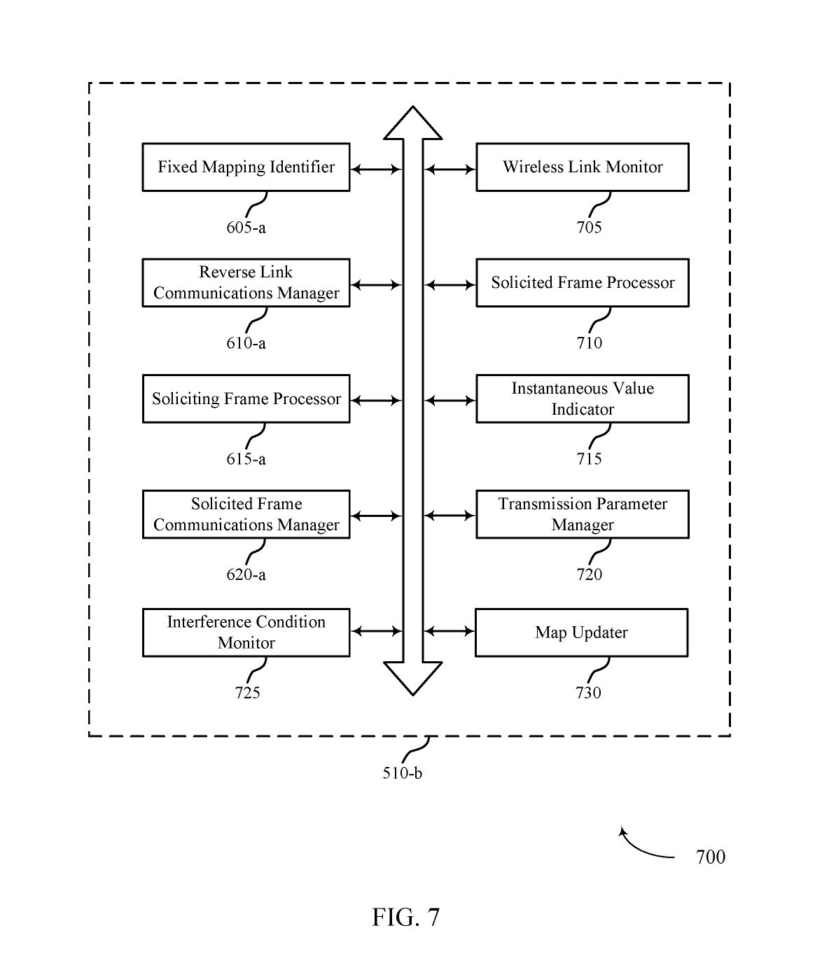

FIG. 7 shows a block diagram 700 of an immediate response frame controller 510-b which may be a component of a wireless device 500 or a wireless device 600 for transmission parameter control for immediate response frames in accordance with various aspects of the present disclosure. The immediate response frame controller 510-b may be an example of aspects of an immediate response frame controller 510 described with reference to FIGS. 5-6. The immediate response frame controller 510-b may include a fixed mapping identifier 605-a, a reverse link communications manager 610-a, a soliciting frame processor 615-a, and a solicited frame communications manager 620-a. Each of these modules may perform the functions described with reference to FIG. 6. The immediate response frame controller 510-b may also include a wireless link monitor 705, a solicited frame processor 710, an instantaneous value indicator 715, a transmission parameter manager 720, an interference condition monitor 725, and a map updater 730.

The wireless link monitor 705 may detect a condition associated with at least the forward link, or the reverse link, or a combination thereof as described with reference to FIGS. 1-4. The wireless link monitor 705 may also transmit the instantaneous value based at least in part on the detected condition. In some examples, the condition may be an imbalanced interference condition between the forward link and the reverse link.

The solicited frame processor 710 may receive a solicited frame BA associated with a BA rate as described with reference to FIGS. 1-4. In some examples, the solicited frame may be the BA. In some examples, the second value for the reverse link transmission parameter may be the BA rate. The solicited frame processor 710 may also attempt to decode the received BA.

The instantaneous value indicator 715 may be configured such that the reserved bit indicates that the instantaneous value for the reverse link transmission parameter may be to be used by the receiving device to transmit the solicited frame in response to the soliciting frame as described with reference to FIGS. 1-4. In some examples, the reserved bit indicates that the instantaneous value for the reverse link transmission parameter may be present in the soliciting frame.

The transmission parameter manager 720 may be configured such that the reverse link transmission parameter may include a transmission rate as described with reference to

FIGS. 1-4. In some examples, the reverse link transmission parameter may be one of a bandwidth channel set, or a transmit power, or a spatial stream number, or a cyclic prefix duration, or an encoding type, or a response time, or a combination thereof.

The interference condition monitor 725 may be configured to identify an interference condition and select the instantaneous value for the reverse link transmission to be included in the soliciting frame based at least in part on the identified interference condition as described with reference to FIGS. 1-4.

The map updater 730 may be configured to periodically update a map between a plurality of forward link transmission parameters and a plurality of reverse link transmission parameters, where the map may be a fixed mapping as described with reference to FIGS. 1-4. In some examples, map updater 730 may be configured to transmit the updated map to the receiving device, where the updated map may be transmitted in the control field, or in one or more management frames, or a combination thereof.

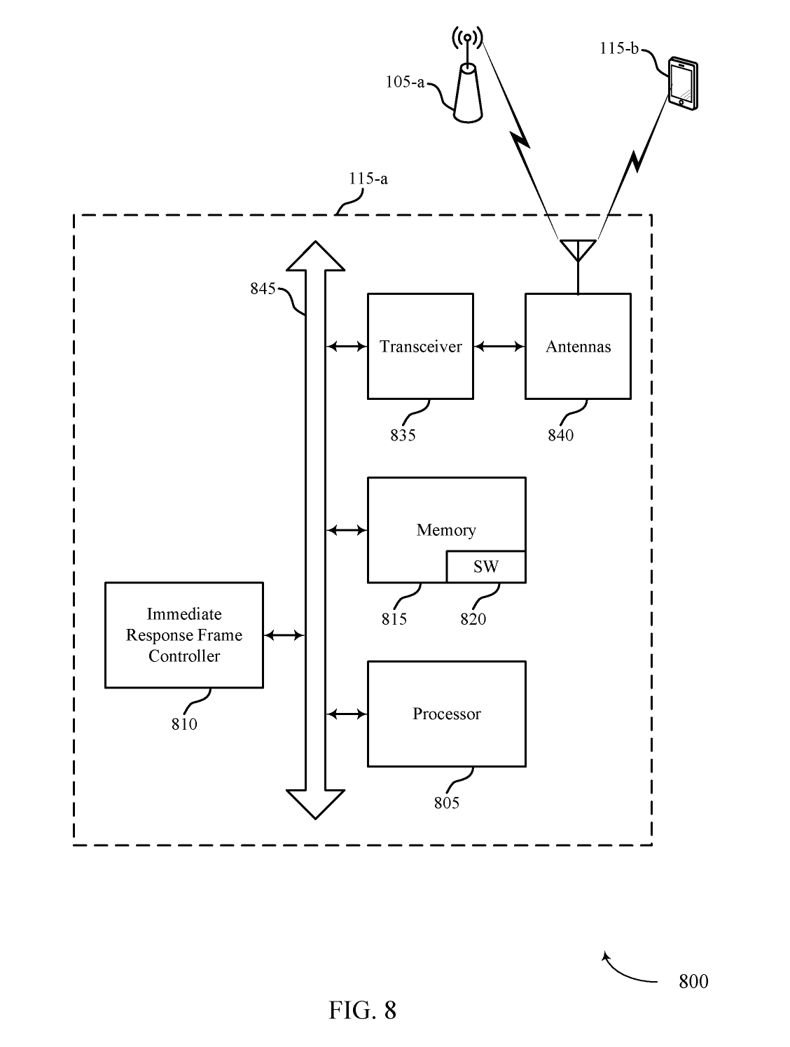

FIG. 8 shows a diagram of a system 800 including a STA 115-a configured for transmission parameter control for immediate response frames in accordance with various aspects of the present disclosure. System 800 may include STA 115-1, which may be an example of a wireless device 500, a wireless device 600, or a STA 115 described with reference to FIGS. 1 and 5-7. STA 115-a may also perform the functions of either of transmitting device 205 or receiving device 210 described with reference to FIGS. 2-4. A second instance of STA 115-a or an AP 105 may then perform of the functions of either of receiving device 210 or transmitting device 205 described with reference to FIGS. 2-4. STA 115-a may include an immediate response frame controller 810, which may be an example of an immediate response frame controller 510 described with reference to FIGS. 5-7. STA 115-a may also include components for bi-directional voice and data communications including components for transmitting communications and components for receiving communications. For example, STA 115-a may communicate bi-directionally with AP 105-a or STA 115-b.

STA 115-a may also include a processor 805, and memory 815 (including software (SW)) 820, a transceiver 835, and one or more antenna(s) 840, each of which may communicate, directly or indirectly, with one another (e.g., via buses 845). The transceiver 835 may communicate bi-directionally, via the antenna(s) 840 or wired or wireless links, with one or more networks, as described above. For example, the transceiver 835 may communicate bi-directionally with an AP 105-a or another STA 115-b. The transceiver 835 may include a modem to modulate the packets and provide the modulated packets to the antenna(s) 840 for transmission, and to demodulate packets received from the antenna(s) 840. While STA 115-a may include a single antenna 840, STA 115-a may also have multiple antennas 840 capable of concurrently transmitting or receiving multiple wireless transmissions.

The memory 815 may include random access memory (RAM) and read only memory (ROM). The memory 815 may store computer-readable, computer-executable software/firmware code 820 including instructions that, when executed, cause the processor 805 to perform various functions described herein (e.g., transmission parameter control for immediate response frames, etc.). Alternatively, the software/firmware code 820 may not be directly executable by the processor 805 but cause a computer (e.g., when compiled and executed) to perform functions described herein. The processor 805 may include an intelligent hardware device, (e.g., a central processing unit (CPU), a microcontroller, an application specific integrated circuit (ASIC), etc.)

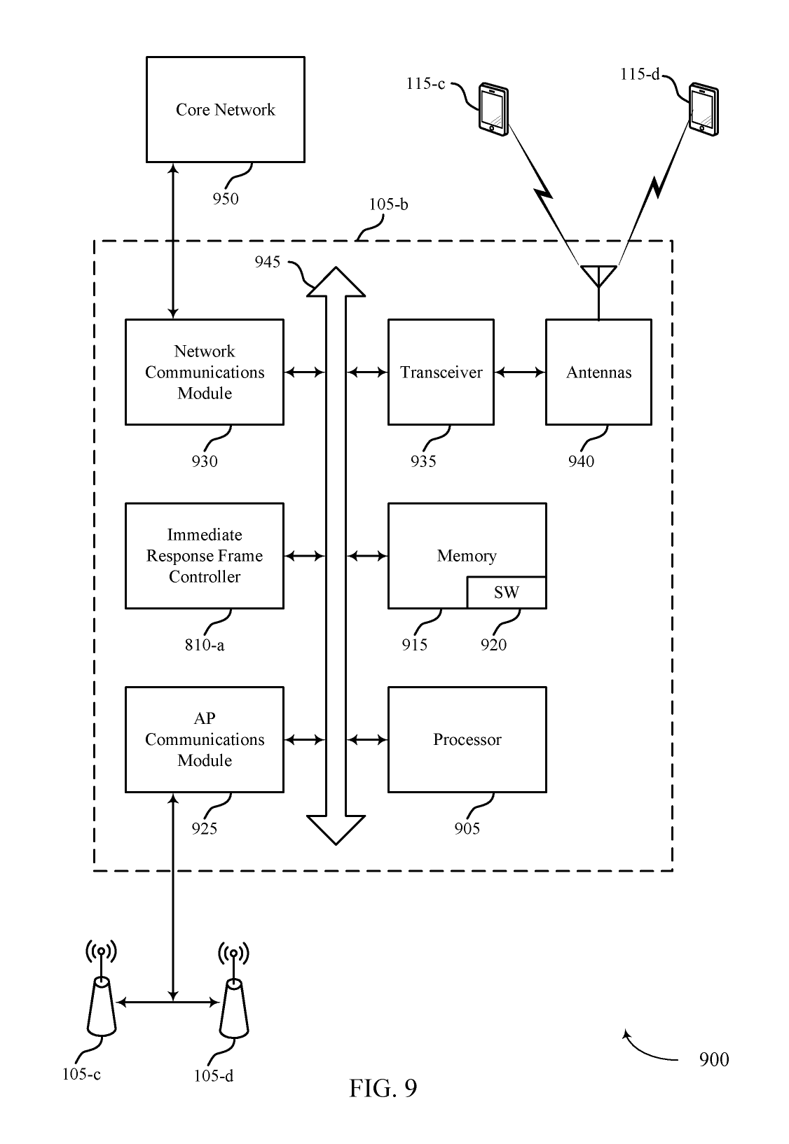

FIG. 9 shows a diagram of a system 900 including an AP 105 configured for transmission parameter control for immediate response frames in accordance with various aspects of the present disclosure. System 900 may include AP 105-b, which may be an example of a wireless device 500, a wireless device 600, or an AP 105 described with reference to FIGS. 1 and 5-8. AP 105-b may also perform the functions of either of transmitting device 205 or receiving device 210 described with reference to FIGS. 2-4. A STA 115 may then perform of the functions of either of receiving device 210 or transmitting device 205, respectively, described with reference to FIGS. 2-4. AP 105-b may include an immediate response frame controller 810-a, which may be an example of the immediate response frame controller 510 described with reference to FIGS. 5-7 or the immediate response frame controller 810 described with reference to FIG. 8. AP 105-b may also include components for bi-directional voice and data communications including components for transmitting communications and components for receiving communications. For example, AP 105-b may communicate bi-directionally with STA 115-c or STA 115-d.

In some cases, AP 105-b may have one or more wired backhaul links. For example, AP 105-b may have a wired backhaul link to a core network 950. AP 105-b may also communicate with other APs or APs 105, such as AP 105-c and AP 105-d via backhaul links. Each of the APs 105 may communicate with STAs 115 using the same or different wireless communications technologies. In some cases, AP 105-b may communicate with other APs such as AP 105-c or AP 105-d utilizing AP communication module 925. In some examples, AP communication module 925 may provide an X2 interface within a Long Term Evolution (LTE)/LTE-A wireless communication network technology to provide communication between some of the APs 105. In some cases, AP 105-b may communicate with the core network 950 through network communications module 930.

The AP 105-b may include a processor 905, memory 915 (including SW 920), transceiver 935, and antenna(s) 940, which each may be in communication, directly or indirectly, with one another (e.g., over bus system 945). The transceiver 935 may be configured to communicate bi-directionally, via the antenna(s) 940, with the STAs 115, which may be multi-mode devices. The transceiver 935 (or other components of the AP 105-b) may also be configured to communicate bi-directionally, via the antennas 940, with one or more other APs. The transceiver 935 may include a modem configured to modulate the packets and provide the modulated packets to the antennas 940 for transmission, and to demodulate packets received from the antennas 940. The AP 105-b may include multiple transceivers 935, each with one or more associated antennas 940. The transceiver may be an example of a combination of a receiver 505 and transmitter 515 of FIGS. 5-6.

The memory 915 may include RAM and ROM. The memory 915 may also store computer-readable, computer-executable software code 920 containing instructions that are configured to, when executed, cause the processor 910 to perform various functions described herein (e.g., transmission parameter control for immediate response frames, selecting coverage enhancement techniques, call processing, database management, message routing, etc.). Alternatively, the software code 920 may not be directly executable by the processor 905 but be configured to cause the computer, e.g., when compiled and executed, to perform functions described herein. The processor 905 may include an intelligent hardware device, e.g., a CPU, a microcontroller, an ASIC, etc. The processor 905 may include various special purpose processors such as encoders, queue processing modules, base band processors, radio head controllers, digital signal processor (DSPs), and the like.

The AP communication module 925 may manage communications with other APs 105. In some cases, a communications management module may include a controller or scheduler for controlling communications with STAs 115 in cooperation with other APs 105. For example, the AP communication module 925 may coordinate scheduling for transmissions to STAs 115 for various interference mitigation techniques such as beamforming or joint transmission.

The components of wireless device 500, wireless device 600, immediate response frame controller 510, and immediate response frame controller 810 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., structured/platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

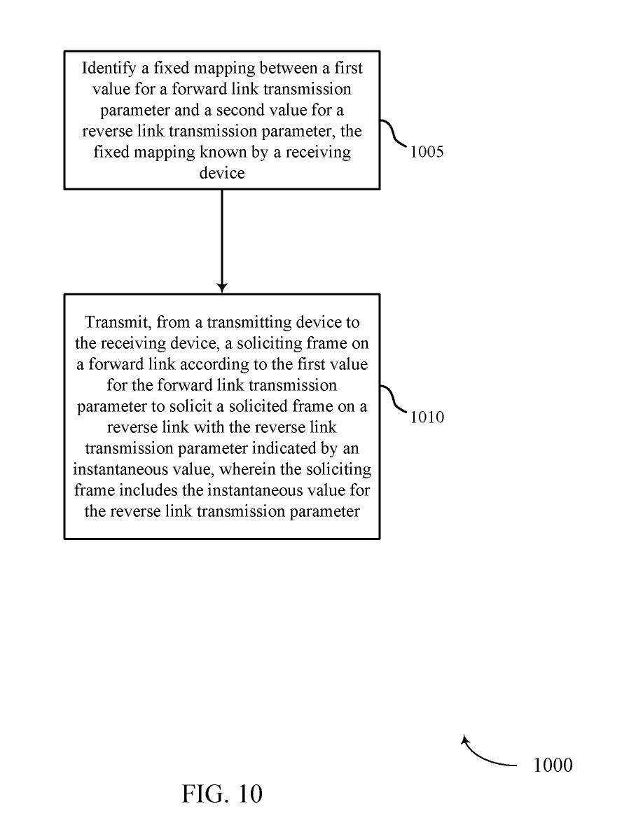

FIG. 10 shows a flowchart illustrating a method 1000 for transmission parameter control for immediate response frames in accordance with various aspects of the present disclosure. The operations of method 1000 may be implemented by a STA 115 or its components, or an AP 105 or its components, as described with reference to FIGS. 1-9, STA 115 or AP 105 operating as a transmitting device 205. For example, the operations of method 1000 may be performed by the immediate response frame controller 510 as described with reference to FIGS. 5-7 or the immediate response frame controller 810 as described with reference to FIGS. 7-8. In some examples, a transmitting device 205 may execute a set of codes to control the functional elements of the transmitting device 205 to perform the functions described below. Additionally or alternatively, the transmitting device 205 may perform aspects the functions described below using special-purpose hardware.

At block 1005, the transmitting device 205 may identify a fixed mapping between a first value for a forward link transmission parameter and a second value for a reverse link transmission parameter, the fixed mapping known by a receiving device as described with reference to FIGS. 1-4. In certain examples, the operations of block 1005 may be performed by the fixed mapping identifier 605 as described with reference to FIG. 6.

At block 1010, the transmitting device 205 may transmit, from a transmitting device to the receiving device, a soliciting frame on a forward link according to the first value for the forward link transmission parameter to solicit a solicited frame on a reverse link with the reverse link transmission parameter indicated by an instantaneous value, wherein the soliciting frame includes the instantaneous value for the reverse link transmission parameter as described with reference to FIGS. 1-4. In certain examples, the operations of block 1010 may be performed by the reverse link communications manager 610 as described with reference to FIG. 6.

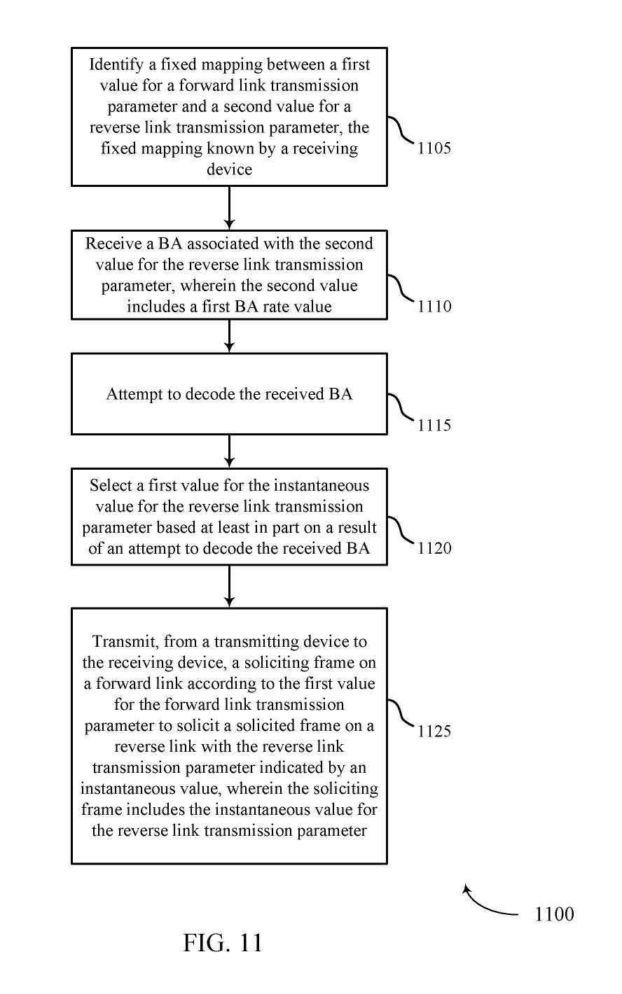

FIG. 11 shows a flowchart illustrating a method 1100 for transmission parameter control for immediate response frames in accordance with various aspects of the present disclosure. The operations of method 1100 may be implemented by a STA 115 or its components, or an AP 105 or its components, as described with reference to FIGS. 1-9, STA 115 or AP 105 operating as a transmitting device 205. For example, the operations of method 1100 may be performed by the immediate response frame controller 510 as described with reference to FIGS. 5-7 or the immediate response frame controller 810 as described with reference to FIGS. 7-8. In some examples, a transmitting device 205 may execute a set of codes to control the functional elements of the transmitting device 205 to perform the functions described below. Additionally or alternatively, the transmitting device 205 may perform aspects the functions described below using special-purpose hardware. The method 1100 may also incorporate aspects of method 1000 of FIG. 10.

At block 1105, the transmitting device 205 may identify a fixed mapping between a first value for a forward link transmission parameter and a second value for a reverse link transmission parameter, the fixed mapping known by a receiving device as described with reference to FIGS. 1-4. In certain examples, the operations of block 1105 may be performed by the fixed mapping identifier 605 as described with reference to FIG. 6.

At block 1110, the transmitting device 205 may receive a BA associated with the second value for the reverse link transmission parameter, wherein the second value includes a first BA rate value as described with reference to FIGS. 1-4. In certain examples, the operations of block 1110 may be performed by the solicited frame processor 710 as described with reference to FIG. 7.

At block 1115, the transmitting device 205 may attempt to decode the received BA as described with reference to FIGS. 1-4. In certain examples, the operations of block 1115 may be performed by the solicited frame processor 710 as described with reference to FIG. 7.

At block 1120, the transmitting device 205 may select a first value for the instantaneous value for the reverse link transmission parameter based at least in part on a result of an attempt to decode the received BA as described with reference to FIGS. 1-4. In certain examples, the operations of block 1120 may be performed by the reverse link communications manager 610 as described with reference to FIG. 6.

At block 1125, the transmitting device 205 may transmit, from a transmitting device to the receiving device, a soliciting frame on a forward link according to the first value for the forward link transmission parameter to solicit a solicited frame on a reverse link with the reverse link transmission parameter indicated by an instantaneous value, wherein the soliciting frame includes the instantaneous value for the reverse link transmission parameter as described with reference to FIGS. 1-4. In certain examples, the operations of block 1125 may be performed by the reverse link communications manager 610 as described with reference to FIG. 6.

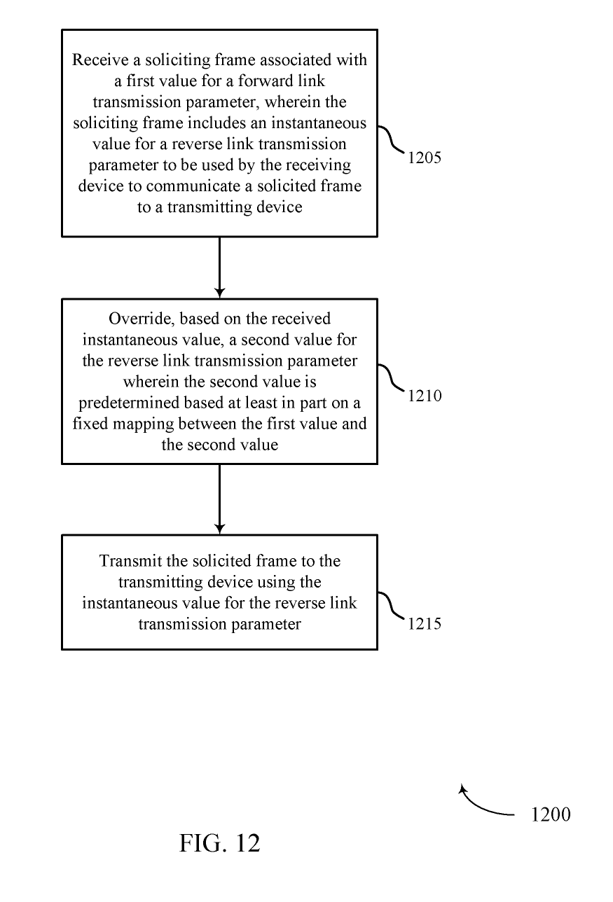

FIG. 12 shows a flowchart illustrating a method 1200 for transmission parameter control for immediate response frames in accordance with various aspects of the present disclosure. The operations of method 1200 may be implemented by a STA 115 or its components, or an AP 105 or its components, as described with reference to FIGS. 1-9, STA 115 or AP 105 operating as a receiving device 210. For example, the operations of method 1200 may be performed by the immediate response frame controller 510 as described with reference to FIGS. 5-7 or the immediate response frame controller 810 as described with reference to FIGS. 7-8. In some examples, a receiving device 210 may execute a set of codes to control the functional elements of the receiving device 210 to perform the functions described below. Additionally or alternatively, the receiving device 210 may perform aspects the functions described below using special-purpose hardware. The method 1200 may also incorporate aspects of method 1000 of FIG. 10 or aspects of method 1100 of FIG. 11.

At block 1205, the receiving device 210 may receive a soliciting frame associated with a first value for a forward link transmission parameter, wherein the soliciting frame includes an instantaneous value for a reverse link transmission parameter to be used by the receiving device to communicate a solicited frame to a transmitting device as described with reference to FIGS. 1-4. In certain examples, the operations of block 1205 may be performed by the soliciting frame processor 615 as described with reference to FIG. 6.

At block 1210, the receiving device 210 may override, based at least in part on the received instantaneous value, a second value for the reverse link transmission parameter, wherein the second value is predetermined based at least in part on a fixed mapping between the first value and the second value as described with reference to FIGS. 1-4. In certain examples, the operations of block 1210 may be performed by the solicited frame communications manager 620 as described with reference to FIG. 6.

At block 1215, the receiving device 210 may transmit the solicited frame to the transmitting device using the instantaneous value for the reverse link transmission parameter as described with reference to FIGS. 1-4. In certain examples, the operations of block 1215 may be performed by the solicited frame communications manager 620 as described with reference to FIG. 6.

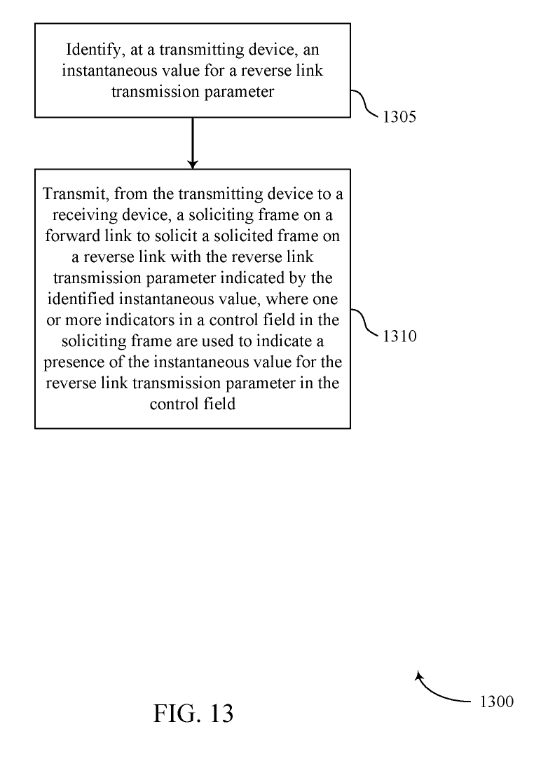

FIG. 13 shows a flowchart illustrating a method 1300 for transmission parameter control for immediate response frames in accordance with various aspects of the present disclosure. The operations of method 1300 may be implemented by a STA 115 or its components as described herein. For example, the operations of method 1300 may be performed by an immediate response frame controller as described with reference to FIGS. 5-9. In some examples, a STA 115 may execute a set of codes to control the functional elements of the device to perform the functions described below. Additionally or alternatively, the STA 115 may perform aspects the functions described below using special-purpose hardware.

At block 1305, the STA 115 may identify, at a transmitting device, an instantaneous value for a reverse link transmission parameter. The operations of block 1305 may be performed according to the methods described with reference to FIGS. 1-6. In certain examples, the operations of block 1305 may be performed by a reverse link communications manager 610 as described with reference to FIGS. 6-7.

At block 1310, the STA 115 may transmit, from the transmitting device to a receiving device, a soliciting frame on a forward link to solicit a solicited frame on a reverse link with the reverse link transmission parameter indicated by the identified instantaneous value, where one or more indicators in a control field in the soliciting frame are used to indicate a presence of the instantaneous value for the reverse link transmission parameter in the control field. The operations of block 1310 may be performed according to the methods described with reference to FIGS. 1-4. In certain examples, the operations of block 1310 may be performed by a reverse link communications manager 610 as described with reference to FIGS. 6-7.

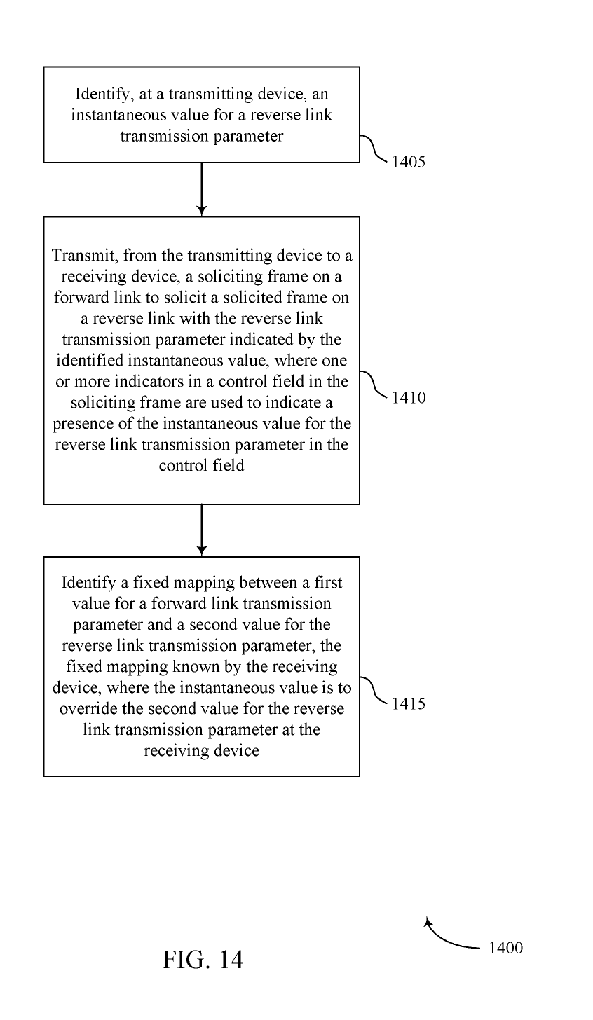

FIG. 14 shows a flowchart illustrating a method 1400 for transmission parameter control for immediate response frames in accordance with various aspects of the present disclosure. The operations of method 1400 may be implemented by a STA 115 or its components as described herein. For example, the operations of method 1400 may be performed by an immediate response frame controller as described with reference to FIGS. 5-9. In some examples, a STA 115 may execute a set of codes to control the functional elements of the device to perform the functions described below. Additionally or alternatively, the STA 115 may perform aspects the functions described below using special-purpose hardware.

At block 1405, the STA 115 may identify, at a transmitting device, an instantaneous value for a reverse link transmission parameter. The operations of block 1405 may be performed according to the methods described with reference to FIGS. 1-4. In certain examples, the operations of block 1405 may be performed by a reverse link communications manager 610 as described with reference to FIGS. 6-7.

At block 1410, the STA 115 may transmit, from the transmitting device to a receiving device, a soliciting frame on a forward link to solicit a solicited frame on a reverse link with the reverse link transmission parameter indicated by the identified instantaneous value, where one or more indicators in a control field in the soliciting frame are used to indicate a presence of the instantaneous value for the reverse link transmission parameter in the control field. The operations of block 1410 may be performed according to the methods described with reference to FIGS. 1-4. In certain examples, the operations of block 1410 may be performed by a reverse link communications manager 610 as described with reference to FIGS. 6-7.

At block 1415, the STA 115 may identify a fixed mapping between a first value for a forward link transmission parameter and a second value for the reverse link transmission parameter, the fixed mapping known by the receiving device, where the instantaneous value is to override the second value for the reverse link transmission parameter at the receiving device. The operations of block 1415 may be performed according to the methods described with reference to FIGS. 1-4. In certain examples, the operations of block 1415 may be performed by a fixed mapping identifier 605 as described with reference to FIGS. 6-7.

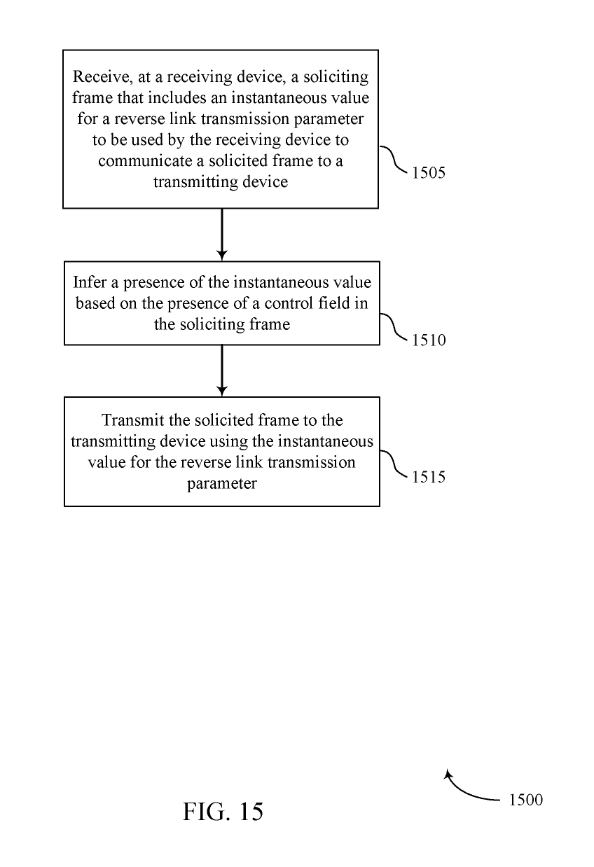

FIG. 15 shows a flowchart illustrating a method 1500 for transmission parameter control for immediate response frames in accordance with various aspects of the present disclosure. The operations of method 1500 may be implemented by a STA 115 or its components as described herein. For example, the operations of method 1500 may be performed by an immediate response frame controller as described with reference to FIGS. 5-9. In some examples, a STA 115 may execute a set of codes to control the functional elements of the device to perform the functions described below. Additionally or alternatively, the STA 115 may perform aspects the functions described below using special-purpose hardware.

At block 1505, the STA 115 may receive, at a receiving device, a soliciting frame that includes an instantaneous value for a reverse link transmission parameter to be used by the receiving device to communicate a solicited frame to a transmitting device. The operations of block 1505 may be performed according to the methods described with reference to FIGS. 1-4. In certain examples, the operations of block 1505 may be performed by a soliciting frame processor 615 as described with reference to FIGS. 6-7.

At block 1510, the STA 115 may infer a presence of the instantaneous value based on the presence of a control field in the soliciting frame. The operations of block 1510 may be performed according to the methods described with reference to FIGS. 1-4. In certain examples, the operations of block 1510 may be performed by a soliciting frame processor 615 as described with reference to FIGS. 6-7.

At block 1515, the STA 115 may transmit the solicited frame to the transmitting device using the instantaneous value for the reverse link transmission parameter. The operations of block 1515 may be performed according to the methods described with reference to FIGS. 1-4. In certain examples, the operations of block 1515 may be performed by a solicited frame communications manager 620 as described with reference to FIGS. 6-7.

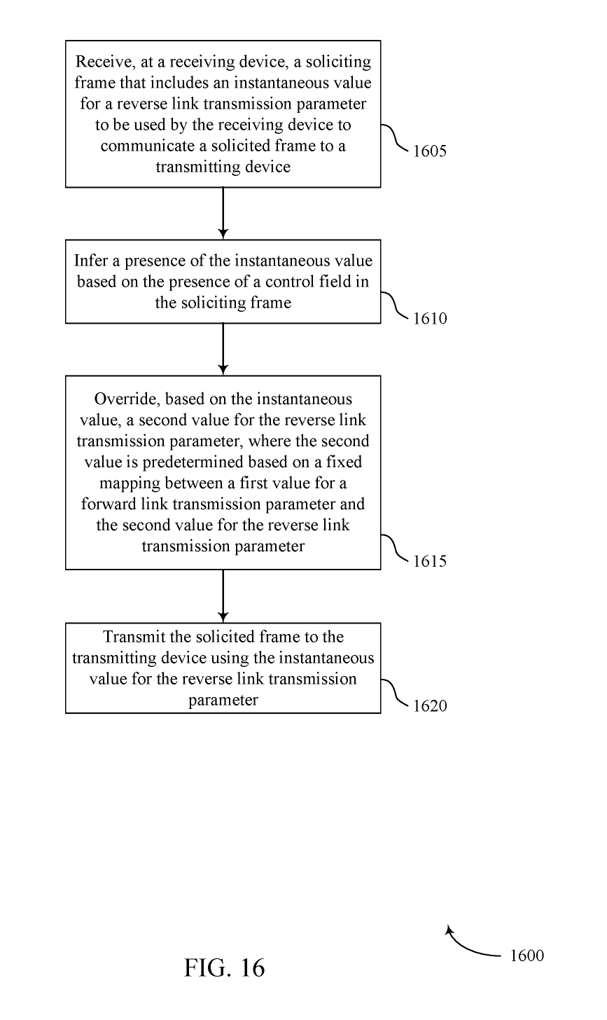

FIG. 16 shows a flowchart illustrating a method 1600 for transmission parameter control for immediate response frames in accordance with various aspects of the present disclosure. The operations of method 1600 may be implemented by a STA 115 or its components as described herein. For example, the operations of method 1600 may be performed by an immediate response frame controller as described with reference to FIGS. 5-9. In some examples, a STA 115 may execute a set of codes to control the functional elements of the device to perform the functions described below. Additionally or alternatively, the STA 115 may perform aspects the functions described below using special-purpose hardware.

At block 1605, the STA 115 may receive, at a receiving device, a soliciting frame that includes an instantaneous value for a reverse link transmission parameter to be used by the receiving device to communicate a solicited frame to a transmitting device. The operations of block 1605 may be performed according to the methods described with reference to FIGS. 1-4. In certain examples, the operations of block 1605 may be performed by a soliciting frame processor 615 as described with reference to FIGS. 6-7.

At block 1610, the STA 115 may infer a presence of the instantaneous value based on the presence of a control field in the soliciting frame. The operations of block 1610 may be performed according to the methods described with reference to FIGS. 1-4. In certain examples, the operations of block 1610 may be performed by a soliciting frame processor 615 as described with reference to FIGS. 6-7.

At block 1615, the STA 115 may override, based on the instantaneous value, a second value for the reverse link transmission parameter, where the second value is predetermined based on a fixed mapping between a first value for a forward link transmission parameter and the second value for the reverse link transmission parameter. The operations of block 1620 may be performed according to the methods described with reference to FIGS. 1-4. In certain examples, the operations of block 1620 may be performed by a soliciting frame processor 615 as described with reference to FIGS. 6-7.

At block 1620, the STA 115 may transmit the solicited frame to the transmitting device using the instantaneous value for the reverse link transmission parameter. The operations of block 1615 may be performed according to the methods described with reference to FIGS. 1-4. In certain examples, the operations of block 1615 may be performed by a solicited frame communications manager 620 as described with reference to FIGS. 6-7.

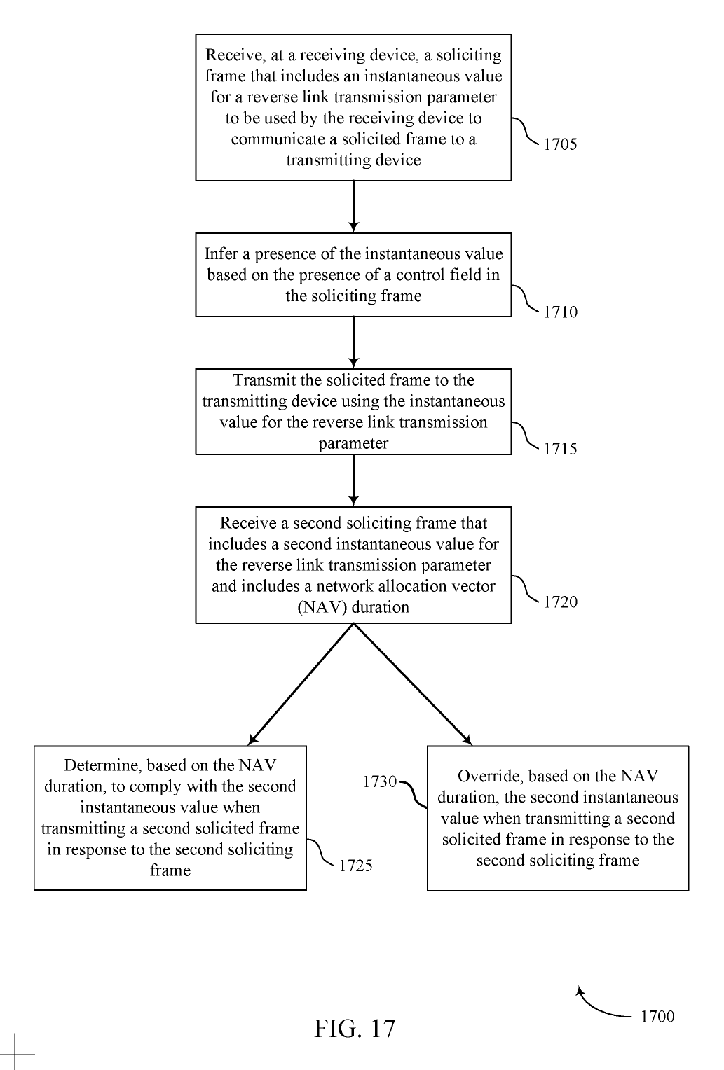

FIG. 17 shows a flowchart illustrating a method 1700 for transmission parameter control for immediate response frames in accordance with various aspects of the present disclosure. The operations of method 1700 may be implemented by a STA 115 or its components as described herein. For example, the operations of method 1700 may be performed by an immediate response frame controller as described with reference to FIGS. 5-9. In some examples, a STA 115 may execute a set of codes to control the functional elements of the device to perform the functions described below. Additionally or alternatively, the STA 115 may perform aspects the functions described below using special-purpose hardware.

At block 1705, the STA 115 may receive, at a receiving device, a soliciting frame that includes an instantaneous value for a reverse link transmission parameter to be used by the receiving device to communicate a solicited frame to a transmitting device. The operations of block 1705 may be performed according to the methods described with reference to FIGS. 1-4. In certain examples, the operations of block 1705 may be performed by a soliciting frame processor 615 as described with reference to FIGS. 6-7.

At block 1710, the STA 115 may infer a presence of the instantaneous value based on the presence of a control field in the soliciting frame. The operations of block 1710 may be performed according to the methods described with reference to FIGS. 1-4. In certain examples, the operations of block 1710 may be performed by a soliciting frame processor 615 as described with reference to FIGS. 6-7.

At block 1715, the STA 115 may transmit the solicited frame to the transmitting device using the instantaneous value for the reverse link transmission parameter. The operations of block 1715 may be performed according to the methods described with reference to FIGS. 1-4. In certain examples, the operations of block 1715 may be performed by a solicited frame communications manager 620 as described with reference to FIGS. 6-7.

At block 1720, the STA 115 may receive a second soliciting frame that includes a second instantaneous value for the reverse link transmission parameter and includes a NAV duration. The operations of block 1720 may be performed according to the methods described with reference to FIGS. 1-4. In certain examples, the operations of block 1720 may be performed by a soliciting frame processor 615 as described with reference to FIGS. 6-7.

At block 1725, the STA 115 may determine, based on the NAV duration, to comply with the second instantaneous value when transmitting a second solicited frame in response to the second soliciting frame. The operations of block 1725 may be performed according to the methods described with reference to FIGS. 1-4. In certain examples, the operations of block 1725 may be performed by a solicited frame communications manager 620 as described with reference to FIGS. 6-7.

Alternatively or additionally to block 1725, at block 1730, the STA 115 may override, based on the NAV duration, the second instantaneous value when transmitting a second solicited frame in response to the second soliciting frame. The operations of block 1730 may be performed according to the methods described with reference to FIGS. 1-4. In certain examples, the operations of block 1730 may be performed by a solicited frame communications manager 620 as described with reference to FIGS. 6-7.

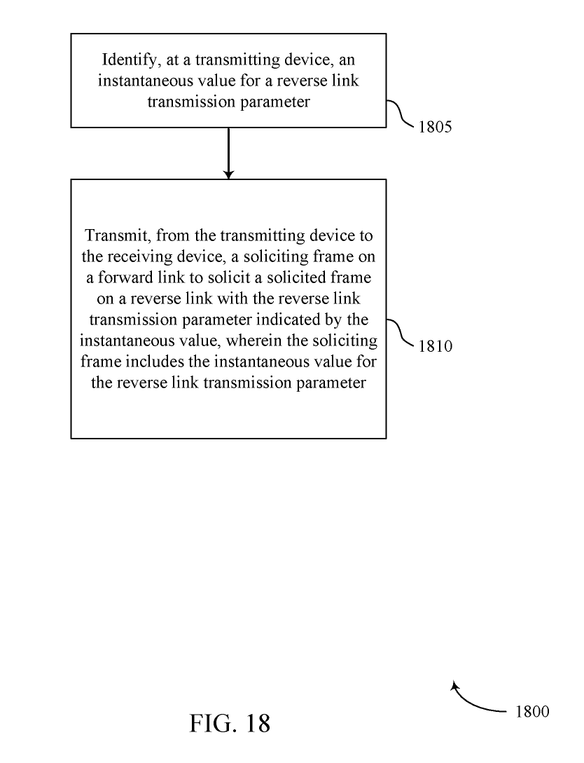

FIG. 18 shows a flowchart illustrating a method 1800 for transmission parameter control for immediate response frames in accordance with various aspects of the present disclosure. The operations of method 1800 may be implemented by a STA 115 or its components as described herein. For example, the operations of method 1800 may be performed by an immediate response frame controller as described with reference to FIGS. 5-9. In some examples, a STA 115 may execute a set of codes to control the functional elements of the device to perform the functions described below. Additionally or alternatively, the STA 115 may perform aspects the functions described below using special-purpose hardware.

At block 1805, the STA 115 may identify, at a transmitting device, an instantaneous value for a reverse link transmission parameter. The operations of block 1805 may be performed according to the methods described with reference to FIGS. 1-4. In certain examples, the operations of block 1805 may be performed by a reverse link communications manager 610 as described with reference to FIGS. 6-7.

At block 1810, the STA 115 may transmit, from a transmitting device to the receiving device, a soliciting frame on a forward link to solicit a solicited frame on a reverse link with the reverse link transmission parameter indicated by the instantaneous value, wherein the soliciting frame includes the instantaneous value for the reverse link transmission parameter. The operations of block 1810 may be performed according to the methods described with reference to FIGS. 1-4. In certain examples, the operations of block 1810 may be performed by a reverse link communications manager 610 as described with reference to FIGS. 6-7.

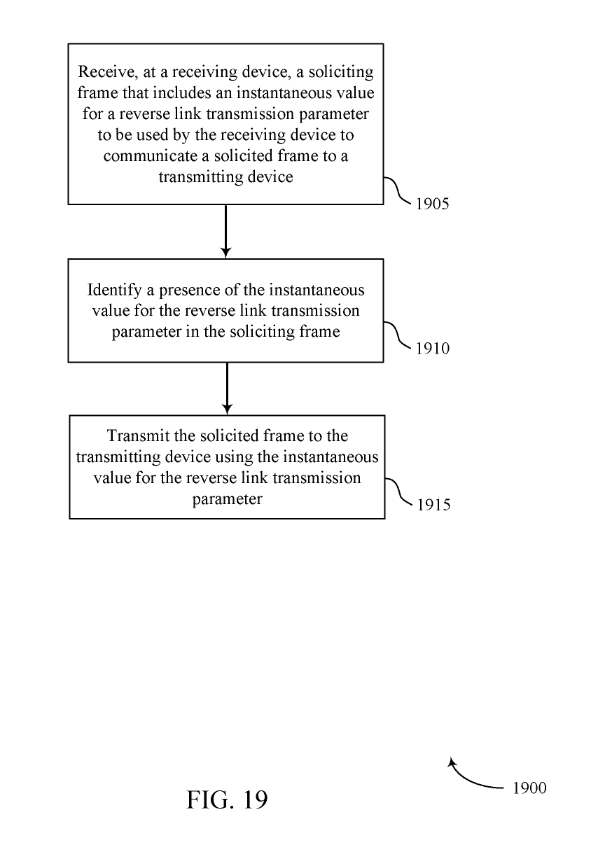

FIG. 19 shows a flowchart illustrating a method 1900 for transmission parameter control for immediate response frames in accordance with various aspects of the present disclosure. The operations of method 1900 may be implemented by a STA 115 or its components as described herein. For example, the operations of method 1900 may be performed by an immediate response frame controller as described with reference to FIGS. 5-9. In some examples, a STA 115 may execute a set of codes to control the functional elements of the device to perform the functions described below. Additionally or alternatively, the STA 115 may perform aspects the functions described below using special-purpose hardware.

At block 1905, the STA 115 may receive, at a receiving device, a soliciting frame that includes an instantaneous value for a reverse link transmission parameter to be used by the receiving device to communicate a solicited frame to a transmitting device. The operations of block 1905 may be performed according to the methods described with reference to FIGS. 1-4. In certain examples, the operations of block 1905 may be performed by a soliciting frame processor 615 as described with reference to FIGS. 6-7.

At block 1910, the STA 115 may identify a presence of the instantaneous value for the reverse link transmission parameter in the soliciting frame. The operations of block 1910 may be performed according to the methods described with reference to FIGS. 1-4. In certain examples, the operations of block 1910 may be performed by a soliciting frame processor 615 as described with reference to FIGS. 6-7.

At block 1915, the STA 115 may transmit the solicited frame to the transmitting device using the instantaneous value for the reverse link transmission parameter. The operations of block 1915 may be performed according to the methods described with reference to FIGS. 1-4. In certain examples, the operations of block 1915 may be performed by a solicited frame communications manager 620 as described with reference to FIGS. 6-7.

Thus, methods 1000, 1100, 1200, 1300, 1400, 1500, 1600, 1700, 1800, and 1900 may provide for transmission parameter control for immediate response frames. It should be noted that methods 1000, 1100, 1200, 1300, 1400, 1500, 1600, 1700, 1800, and 1900 describe possible implementation, and that the operations and the steps may be rearranged or otherwise modified such that other implementations are possible. In some examples, aspects from two or more of the methods 1000, 1100, 1200, 1300, 1400, 1500, 1600, 1700, 1800, and 1900 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. An apparatus for wireless communication, comprising:
a memory that stores instructions; and
a processor coupled with the memory, wherein the processor and the memory are configured to:
identify, at a transmitting device, an instantaneous value for a reverse link transmission parameter; and
transmit, from the transmitting device to a receiving device, a soliciting frame on a forward link to solicit a solicited frame on a reverse link with the reverse link transmission parameter indicated by the instantaneous value, wherein the soliciting frame includes the instantaneous value for the reverse link transmission parameter.

2. The apparatus of claim 1, wherein the apparatus is a wireless communication terminal and further comprises an antenna and a transceiver.

3. The apparatus of claim 1, wherein a presence of one or more indicators in a control field in the soliciting frame is used to indicate a presence of the instantaneous value for the reverse link transmission parameter in the control field.

4. The apparatus of claim 3, wherein:
the control field comprises a link adaptation field, or an immediate response rate field, or a combination thereof; and
the control field is a high efficiency variant of a high throughput control field.

5. The apparatus of claim 3, wherein the one or more indicators comprise a modulation and coding scheme (MCS) value, or a number of spatial streams (NSS), or a combination thereof.

6. The apparatus of claim 3, wherein at least one bit in the control field of the soliciting frame is used to indicate that the instantaneous value for the reverse link transmission parameter is present in the control field of the soliciting frame.

7. The apparatus of claim 1, wherein the instantaneous value for the reverse link transmission parameter is indicated in a link adaptation field, or in a trigger frame field, or in a receiver operation mode indication (ROMI) field, or by at least one redefined bit in the soliciting frame, or by at least one reserved bit in the soliciting frame, or a combination thereof.

8. The apparatus of claim 1, wherein the processor and the memory are further configured to:
identify an interference condition at the transmitting device; and
select the instantaneous value for the reverse link transmission to be included in the soliciting frame based at least in part on the identified interference condition.

9. The apparatus of claim 1, wherein the processor and the memory are further configured to:
identify a fixed mapping between a first value for a forward link transmission parameter and a second value for the reverse link transmission parameter, the fixed mapping known by the receiving device.

10. The apparatus of claim 9, wherein the processor and the memory are further configured to:
periodically update a map between a plurality of forward link transmission parameters and a plurality of reverse link transmission parameters, wherein the map comprises the fixed mapping; and
transmit the updated map to the receiving device.

11. The apparatus of claim 9, wherein the processor and the memory are further configured to:
transmit, from the transmitting device to the receiving device, a second soliciting frame on the forward link with the first value for the forward link transmission parameter and without the instantaneous value for the reverse link transmission parameter, to solicit a second solicited frame on the reverse link according to the second value for the reverse link transmission parameter predetermined by the fixed mapping.

12. The apparatus of claim 9, wherein the instantaneous value comprises an absolute value, or a relative value that indicates a difference from the second value associated with the fixed mapping known by the receiving device.

13. The apparatus of claim 1, wherein the processor and the memory are further configured to:
detect an imbalanced interference condition associated with at least the forward link, or the reverse link, or a combination thereof;
select a value for the instantaneous value based at least in part on the detected imbalanced interference condition; and
determine to include the selected value for the instantaneous value in the soliciting frame based at least in part on the detected imbalanced interference condition.

14. The apparatus of claim 1, wherein the processor and the memory are further configured to:
receive, from the receiving device, a block acknowledgement (BA) associated with a second value for the reverse link transmission parameter, wherein the second value comprises a first BA rate value; and
select a first value for the instantaneous value for the reverse link transmission parameter based at least in part on a result of an attempt to decode the received BA.

15. The apparatus of claim 14, wherein the processor and the memory are further configured to:
continue to transmit, to the receiving device, a plurality of soliciting frames that comprise the instantaneous value for the reverse link transmission parameter for a predefined number of soliciting frames.

16. The apparatus of claim 1, wherein the reverse link transmission parameter comprises one of a transmission rate, or a bandwidth channel set, or a transmit power, or a spatial stream number, or a cyclic prefix duration, or an encoding type, or a response time, or a combination thereof.

17. A method for wireless communication, comprising:
identifying, at a transmitting device, an instantaneous value for a reverse link transmission parameter; and
transmitting, from the transmitting device to a receiving device, a soliciting frame on a forward link to solicit a solicited frame on a reverse link with the reverse link transmission parameter indicated by the instantaneous value, wherein the soliciting frame includes the instantaneous value for the reverse link transmission parameter.

18. The method of claim 17, further comprising:
identifying a fixed mapping between a first value for a forward link transmission parameter and a second value for the reverse link transmission parameter, the fixed mapping known by the receiving device.

19. The method of claim 17, wherein a presence of one or more indicators in a control field in the soliciting frame is used to indicate a presence of the instantaneous value for the reverse link transmission parameter in the control field.

20. A non-transitory computer readable medium storing code for wireless communication, the code comprising instructions executable by a processor to:
identify, at a transmitting device, an instantaneous value for a reverse link transmission parameter; and
transmit, from the transmitting device to a receiving device, a soliciting frame on a forward link to solicit a solicited frame on a reverse link with the reverse link transmission parameter indicated by the instantaneous value, wherein the soliciting frame includes the instantaneous value for the reverse link transmission parameter.
